(19) United States
(12) Patent Application Publication
(10) Pub. No.: US 2025/0113826 A1
(43) Pub. Date: Apr. 10, 2025

(54) AN AGROCHEMICAL COMBINATION

(71) Applicant: UPL LIMITED, Mumbai (IN)

(72) Inventors: Giuvan LENZ, Sao Paulo (BR); Ganesh RAO, Mumbai (IN)

(21) Appl. No.: 18/700,860

(22) PCT Filed: Oct. 17, 2022
(86) PCT No.: PCT/IN2022/050921

§ 371 Date: Apr. 12, 2024

(30) Foreign Application Priority Data
Oct. 18, 2021 (IN) 202121047126

(51) Int. Cl. A01N 57/20; A01N 37/38; A01N 43/40; A01N 43/50; A01N 43/54; A01P 13/00

(52) U.S. Cl. CPC A01N 57/20; A01N 37/38; A01N 43/40; A01N 43/50; A01N 43/54; A01P 13/00

(57) ABSTRACT

Described herein are combinations of glufosinate, salts or esters thereof or L-glufosinate, salts or esters thereof with at least two herbicides. The resulting combinations may be synergistic. Also described are compositions, methods of use and kit-of-parts of the same.

### FIELD OF THE INVENTION

The present invention relates to an herbicidal combination for controlling weeds. More particularly, the present invention relates to synergistic herbicidal combinations, compositions, kits-in-part and method for controlling undesirable weeds.

### BACKGROUND OF THE INVENTION

Weeds are undesirable plants that are detrimental to agriculture and significantly affect crop yields. Farmers use various types of herbicides to control weeds. Herbicides with varied modes of action are generally combined, which allows for broader spectrum of control and managing resistance to herbicides. However, the combinations currently known are not sufficient to control the resistant and persistent weeds.

Additionally, the combination of herbicides may not always result in the desired effect. Combinations of herbicides may result in an additive effect or an antagonistic effect. It may also result in phytotoxicity to the crops making it an undesirable combination. Consequently, herbicides need to be carefully selected so that they can be combined to offer a synergistic effect that would control weeds while having no phytotoxic effect on the crop and reduce the chances of the weeds developing resistance to a particular herbicide.

Accordingly, there is a need in the art for a synergistic herbicidal combination, composition, method and kits for protecting crops from persistent weeds, which helps in resistance management, reduces dosage of herbicides used and that has excellent residual effects.

### OBJECTIVE OF THE INVENTION

It is an objective of the present invention to provide a synergistic combination for controlling weeds.

It is an objective of the present invention to provide a combination for efficient weed control, weed suppression and eradication.

It is an object of the present invention to provide a combination of highly effective herbicidal actives for selective and non-selective weed control.

It is another object of the present invention to provide a synergistic herbicidal combination to control, suppress or prevent a wide spectrum of weeds and target plants, both dicotyledonous and monocotyledonous, broad-leaved, and grassy weeds.

It is an objective of the present invention to provide a synergistic combination for controlling weeds, comprising glufosinate or L-glufosinate and at least two herbicides selected from nitrophenyl ether, imidazolinone, organophosphorous, dicarboximide, phenoxyacetic, pyridine, cyclohexene oxime, aryloxyphenoxypropionic, triazolone class of herbicides, and/or uracil class of herbicides.

It is an objective of the present invention to provide a composition for controlling weeds, comprising glufosinate or L-glufosinate and at least two herbicides selected from nitrophenyl ether, imidazolinone, organophosphorous, dicarboximide, phenoxyacetic, pyridine, cyclohexene oxime, aryloxyphenoxypropionic, triazolone class of herbicides, and/or uracil class of herbicides.

It is an objective of the present invention to provide solid or liquid formulations for controlling weeds.

It is an objective of the present invention to provide a method of controlling weeds, by application of a synergistic herbicidal combination comprising glufosinate or L-glufosinate and at least two herbicides selected from nitrophenyl ether, imidazolinone, organophosphorous, dicarboximide, phenoxyacetic, pyridine, cyclohexene oxime, aryloxyphenoxypropionic, triazolone class of herbicides, and/or uracil class of herbicides.

It is an objective of the present invention to provide a method for increasing yield in a crop by application of a synergistic combination.

It is an objective of the present invention to provide a method for improving the plant health by application of a synergistic combination at the desired locus.

It is an objective of the present invention to provide a combination or composition for use in controlling undesirable vegetation.

Additionally, it is an object of the invention to provide a method of controlling resistant varieties of weeds with a suitable herbicidal combination.

It is an object of the present invention to provide a combination of highly effective herbicidal actives for an efficient burn-down program.

It is an objective of the present invention to provide a kit-of-parts comprising a plurality of components.

### SUMMARY OF THE INVENTION

In an aspect, the present invention provides a combination for controlling the growth of undesirable vegetation, said combination comprising glufosinate, salts or esters thereof, and at least two herbicides selected from:
(a) nitrophenyl ether class of herbicides;
(b) imidazolinone class of herbicides;
(c) organophosphorous class of herbicides;
(d) dicarboximide class of herbicides;
(e) phenoxyacetic class of herbicides;
(f) pyridine class of herbicides;
(g) cyclohexene oxime class of herbicides;
(h) aryloxyphenoxypropionic class of herbicides;
(i) triazolone class of herbicides; and/or
(j) uracil class of herbicides.

In another aspect, there is provided a composition for controlling the growth of undesirable vegetation, the composition comprising glufosinate, salts or esters thereof, at least two herbicides selected from:
(a) nitrophenyl ether class of herbicides;
(b) imidazolinone class of herbicides;
(c) organophosphorous class of herbicides;
(d) dicarboximide class of herbicides;
(e) phenoxyacetic class of herbicides;
(f) pyridine class of herbicides;
(g) cyclohexene oxime class of herbicides;
(h) aryloxyphenoxypropionic class of herbicides;
(i) triazolone class of herbicides; and/or
(j) uracil class of herbicides;
   and at least one agrochemically suitable excipient.

In a preferred embodiment, the glufosinate, salts or esters thereof, is L-glufosinate, salts or esters thereof.

Preferably, the second and third herbicides may be selected from within the same class of herbicides.

Preferably, the second and third herbicides may be selected from within different classes of herbicides.

In accordance with another aspect, the weight ratio of glufosinate and the at least two herbicides ranges from 1:100:100 to 100:1:1.

In accordance with another aspect, the weight ratio of glufosinate and the at least two herbicides ranges from 1:75:75 to 75:1:1.

In accordance with another aspect, there is provided a method of controlling the growth of undesirable vegetation, the method comprising treating the locus at which control is desired with a synergistic combination comprising glufosinate, salts or esters thereof, and at least two herbicides selected from:
(a) nitrophenyl ether class of herbicides;
(b) imidazolinone class of herbicides;
(c) organophosphorous class of herbicides;
(d) dicarboximide class of herbicides;
(e) phenoxyacetic class of herbicides;
(f) pyridine class of herbicides;
(g) cyclohexene oxime class of herbicides;
(h) aryloxyphenoxypropionic class of herbicides;
(i) triazolone class of herbicides; and/or
(j) uracil class of herbicides.

Preferably, the second and third herbicides may be selected from within the same class of herbicides.

Preferably, the second and third herbicides may be selected from within different classes of herbicides.

Preferably, the glufosinate, salts or esters thereof, is L-glufosinate, salts or esters thereof.

Preferably, the second herbicide is selected from the nitrophenyl ether class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the imidazolinone class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the organophosphorus class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the dicarboximide class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the phenoxyacetic class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the pyridine class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the cyclohexene oxime class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the aryloxyphenoxypropionic class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the triazolone class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the uracil class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

In accordance with another aspect, there is provided a method of controlling the growth of undesirable vegetation, the method comprising treating the locus with a synergistic combination of glufosinate, an herbicide selected from the imidazolinone class of herbicides, and a herbicide selected from the triazolone class of herbicides.

In accordance with another aspect, the weight ratio of glufosinate, the herbicide selected from the imidazolinone class of herbicides, and the herbicide selected from the triazolone class of herbicides ranges from 1:100:100 to 100:1:1.

In accordance with another aspect, the weight ratio of glufosinate, the herbicide selected from the imidazolinone class of herbicides, and the herbicide selected from the triazolone class of herbicides ranges from 1:75:75 to 75:1:1.

In accordance with yet another aspect, the combinations, compositions and methods of the present invention are used for controlling weeds in a range of crops.

In accordance with yet another aspect, there is provided a kit-of-parts comprising a plurality of components that may be admixed before use.

### DETAILED DESCRIPTION OF THE INVENTION

Discussed below are some representative embodiments of the present invention. The invention in its broader aspects is not limited to the specific details and representative methods. Illustrative examples are described in this section in connection with the embodiments and methods provided.

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about” and is meant to encompass variations of ±10%, ±5%, ±1%, ±0.5%, or even ±0.1% of the specified value as well as the specified value.

It is to be noted that, as used in the specification, the singular forms “a,” “an,” and “the” include plural referents unless the context clearly dictates otherwise. Thus, for example, reference to a composition containing “a surfactant” includes a mixture of two or more surfactants. It should also be noted that the term “‘or” is generally employed in its sense including “and/or” unless the content clearly dictates otherwise. The terms “emulsifier” and “surfactant” mean essentially the same thing and may be used interchangeably. Further, the terms “composition” or “formulation” also mean essentially the same thing and may be used interchangeably.

The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

The expression of various quantities in terms of “%” or “% w/w” means the percentage by weight of the total solution or composition unless otherwise specified.

The terms “plants” and “vegetation” include, but are not limited to, germinant seeds, emerging seedlings, plants emerging from vegetative propagules, and established vegetation. The term ‘plants’ refers to all physical parts of a plant, including seeds, seedlings, saplings, roots, tubers, stems, stalks, foliage and fruits. The term “weed” refers to unwanted vegetation and includes any plant which grows where it is not wanted, including pesticide resistant plants. In the broadest sense, the term “weed” refers to plants which grow in locations in which they are not desired. In other words, a “weed” is a plant in which in the context of a crop is undesirable due to competition for water, nutrients, sunlight, soil, etc. The term may also refer to crop plants which are undesirable at a location.

The terms “undesirable vegetation”, “harmful plants”, “unwanted plants”, “weeds” and “weed species”, as used herein, are synonyms.

Typically, the combinations/compositions of the present invention are applied to the targeted weed or to their locus or to the crop/plant. The term “locus” as used herein shall denote the vicinity of a desired crop in which weed control, typically selective weed control is desired.

The locus includes the vicinity of desired crop plants wherein the weed infestation has either emerged or is yet to emerge. The term crop shall include a multitude of desired crop plants or an individual crop plant growing at a locus. The said locus could be a weed, an area adjacent to the weed, soil adapted to support growth of the weed, a root of the weed and/or foliage of the weed. The ‘locus’ is intended to include soil, seeds, and seedlings as well as established vegetation.

In any aspect or embodiment described hereinbelow, the phrase comprising may be replaced by the phrases “consisting of’ or “consisting essentially of’ or “consisting substantially of’. In these aspects or embodiment, the combination or composition described includes or comprises or consists of or consists essentially of or consists substantially of the specific components recited therein, to the exclusion of other herbicides or fungicides or insecticide or plant growth promoting agents or adjuvants, or excipients not specifically recited therein.

The present invention, in all its aspects, is described in detail as follows:

Glufosinate (phosphinothricin; DL-homoalanin-4-yl(methyl)phosphinic acid) is a racemic phosphinico amino acid (Hoerlein, G. 1994; glufosinate (Phosphinothricin), a natural amino acid with unexpected herbicidal properties. Rev. of Environmental Contamination and Toxicology 138, 73-145). Its ammonium salt (glufosinate-ammonium) is widely used as a non-selective herbicide and is the active ingredient of the commercial herbicide formulations Basta™, Buster™, Challenge™, Conquest™, Dash™, Final™, Finale™, Liberty™ and Ignite™. The L-isomer of glufosinate is a structural analogue of glutamate and, therefore, is a competitive inhibitor of the enzyme glutamine synthetase (GS) of bacteria and plants (Bayer et al, 1972, Phosphinothricin and phosphinothricyl-alanyl-alanin. Helv. Chim. Acta 55, 224-239; Leason et al., 1982, Inhibition of pea leaf glutamine synthetase by methioninsulfoximine, Phosphinothricin and other glutamate analogs. J. Phytochem. 21, 855-857). The D-isomer is not a GS inhibitor and is not herbicidally active.

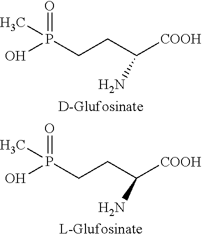

Fig. 1. Chemical structures of D-glufosinate and L-glufosinate.

It has surprisingly been found by the present inventors that a range of weeds can be completely controlled by the combination of glufosinate, salts or esters thereof, and at least two herbicides selected from:
(a) nitrophenyl ether class of herbicides;
(b) imidazolinone class of herbicides;
(c) organophosphorous class of herbicides;
(d) dicarboximide class of herbicides;
(e) phenoxyacetic class of herbicides;
(f) pyridine class of herbicides;
(g) cyclohexene oxime class of herbicides;
(h) aryloxyphenoxypropionic class of herbicides;
(i) triazolone class of herbicides; and/or
(j) uracil class of herbicides.

More surprisingly, it was found that this combination, between glufosinate, salts or esters thereof, and at least two herbicides provided synergistic effect in controlling a range of weeds. The degree of synergistic enhancement in efficacy of the above combination towards control of weeds was unpredictable and unexpected.

As used herein, the term “glufosinate” refers to any molecule which is a racemic phosphinico amino acid or a salt thereof. The term also includes forms and isomers of glufosinate such as glufosinate-p (L-glufosinate), D-glufosinate, and sodium, potassium or ammonium salts thereof. The term can generically refer to any form of glufosinate or its salt such as solvates, hydrates, anhydrous form, polymorph forms, pseudo polymorph forms, amorphous form or mixture thereof.

Preferably, the herbicide glufosinate, salts or esters thereof, used in any aspect or embodiment described herein may be replaced by, or used interchangeably as, its L-isomer i.e. L-glufosinate, salts or esters thereof.

As used herein, the term “L-glufosinate” refers to the L-isomer of glufosinate or a salt thereof. The L-isomer of glufosinate is a structural analogue of glutamate and, therefore, is a competitive inhibitor of the enzyme glutamine synthetase (GS) of bacteria and plants. The L-enantiomer of glufosinate acts by inhibition of glutamine synthetase thereby causing accumulation of toxic levels of ammonium ion and indirectly stopping photosynthesis. It is also known as phosphinothricin or (S)-2-amino-4-(hydroxy(methyl)phosphonyl)butanoic acid. The term as used herein includes free acid form, salts and ester forms of L-glufosinate. The term very commonly covers derivatives such as salts and esters of L-glufosinate. The term can generically refer to any form of L-glufosinate or its salt such as free acid, solvates, hydrates, anhydrous form, polymorph forms, pseudo polymorph forms, amorphous form or mixture thereof, and sodium, potassium or ammonium salts. The term “L-glufosinate or a salt thereof” encompasses any salt of L-glufosinate, preferable sodium, potassium and ammonium salts. The salts of L-glufosinate such as monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)⁺ salt, and —NH₂(CH₃)(C₂H₄OH)⁺ salt are included in the definition. The agronomically acceptable salts include L-glufosinate-ammonium, L-glufosinate-sodium, and L-glufosinate-potassium. The term may also refer to an isomeric (racemic) mixture of L-glufosinate, D-glufosinate and salts thereof, wherein the content of L-glufosinate or a salt thereof in the mixture is 70% or greater, preferably 80% or greater and more preferably 90% or greater. Typically, the ratio of L-glufosinate:D-glufosinate can be in the range from about 95:5 to about 99.9:0.1.

Therefore, in an embodiment, the preferred glufosinate, salts or esters thereof herbicide is L-glufosinate, salts or esters thereof.

The term ‘herbicide’ as used herein denotes a compound which controls or modifies the growth of plants. The term ‘herbicidally effective amount’ indicates the quantity of such a compound or combination of such compounds which is capable of producing a controlling or modifying effect on the growth of plants. Controlling effects include all deviation from natural development, for example: killing, retardation, leaf burn, albinism, dwarfing etc.

In an embodiment, the present invention provides an herbicidal combination comprising glufosinate, salts or esters thereof, and at least two herbicides selected from:
(a) nitrophenyl ether class of herbicides;
(b) imidazolinone class of herbicides;
(c) organophosphorous class of herbicides;
(d) dicarboximide class of herbicides;
(e) phenoxyacetic class of herbicides;
(f) pyridine class of herbicides;
(g) cyclohexene oxime class of herbicides;
(h) aryloxyphenoxypropionic class of herbicides;
(i) triazolone class of herbicides; and/or
(j) uracil class of herbicides.

In an embodiment, the present invention provides an herbicidal combination for controlling the growth of undesirable vegetation, said combination comprising glufosinate, salts or esters thereof, and at least two herbicides selected from:
(a) nitrophenyl ether class of herbicides;
(b) imidazolinone class of herbicides;
(c) organophosphorous class of herbicides;
(d) dicarboximide class of herbicides;
(e) phenoxyacetic class of herbicides;
(f) pyridine class of herbicides;
(g) cyclohexene oxime class of herbicides;
(h) aryloxyphenoxypropionic class of herbicides;
(i) triazolone class of herbicides; and/or
(j) uracil class of herbicides.

In a preferred embodiment, glufosinate, salts or esters thereof is L-glufosinate, salts or esters thereof.

In an embodiment, the present invention provides an herbicidal combination for controlling the growth of undesirable vegetation, said combination comprising L-glufosinate, salts or esters thereof, and at least two herbicides selected from:
(a) nitrophenyl ether class of herbicides;
(b) imidazolinone class of herbicides;
(c) organophosphorous class of herbicides;
(d) dicarboximide class of herbicides;
(e) phenoxyacetic class of herbicides;
(f) pyridine class of herbicides;
(g) cyclohexene oxime class of herbicides;
(h) aryloxyphenoxypropionic class of herbicides;
(i) triazolone class of herbicides; and/or
(j) uracil class of herbicides.

Preferably, the second and third herbicides may be selected from within the same class of herbicides.

Preferably, the second and third herbicides may be selected from within different classes of herbicides.

Preferably, the glufosinate, salts or esters thereof may be L-glufosinate, salts or esters thereof.

Preferably, the second herbicide is selected from the nitrophenyl ether class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the imidazolinone class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the organophosphorus class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the dicarboximide class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the phenoxyacetic class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the pyridine class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the cyclohexene oxime class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the aryloxyphenoxypropionic class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the triazolone class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

Preferably, the second herbicide is selected from the uracil class of herbicides, and the third herbicide is selected from the nitrophenyl ether class of herbicides; or the imidazolinone class of herbicides; or the organophosphorous class of herbicides; or dicarboximide class of herbicides; or phenoxyacetic class of herbicides; or the pyridine class of herbicides; or the cyclohexene oxime class of herbicides; or the aryloxyphenoxypropionic class of herbicides; or the triazolone class of herbicides; or the uracil class of herbicides.

In an embodiment, said combinations of the present disclosure are tank-mix combinations.

In an embodiment, nitrophenyl ether class herbicide is selected from the group consisting of oxyfluorfen, acifluorfen, aclonifen, bifenox, chlomethoxyfen, chlornitrofen, etnipromid, fluorodifen, fluoroglycofen, fluoronitrofen, fomesafen, fucaomi, furyloxyfen, halosafen, lactofen, nitrofen, nitrofluorfen, and combinations thereof.

In a preferred embodiment, the nitrophenyl ether class herbicide is oxyfluorfen.

In a preferred embodiment, the nitrophenyl ether class herbicide is acifluorfen.

In a preferred embodiment, the nitrophenyl ether class herbicide is fomesafen.

In a preferred embodiment, the nitrophenyl ether class herbicide is aclonifen.

In an embodiment, the imidazolinone class herbicide is selected from the group consisting of imazethapyr, imazamethabenz, imazamox, imazapic, imazapyr, imazaquin and combinations thereof.

In a preferred embodiment, the imidazolinone class herbicide is imazethapyr.

In a preferred embodiment, the imidazolinone class herbicide is imazamox.

In a preferred embodiment, the imidazolinone class herbicide is imazapyr.

In a preferred embodiment, the imidazolinone class herbicide is imazapic.

In an embodiment, the organophosphorous class of herbicide is selected from the group consisting of glyphosate, amiprofos-methyl, amiprophos, anilofos, bensulide, bilanafos, butamifos, clacyfos, 2,4-DEP (2,4-Dichlorophenoxyethylphosphite), DMPA (O-(2,4-Dichlorophenyl) O-Methyl Isopropylphosphoramidothioate), EBEP (ethyl bis(2-ethylhexyl)phosphinate), fosamine, huangcaoling, piperophos, shuangjiaancaolin and combinations thereof.

In a preferred embodiment, the organophosphorous class herbicide is glyphosate.

In an embodiment, the dicarboximide class herbicide is selected from the group consisting of flumioxazin, cinidon-ethyl, flumezin, flumiclorac, flumipropyn, and combinations thereof.

In a preferred embodiment, the dicarboximide class herbicide is flumioxazin.

In an embodiment, the phenoxyacetic class herbicide is selected from the group consisting of clacyfos, 2,4-D, 4-CPA (p-Chlorophenoxyacetic acid), 3,4-DA, MCPA (2-METHYL-4-CHLOROPHENOXYACETIC ACID), MCPA-thioethyl, 2,4,5-T, and combinations thereof.

In a preferred embodiment, the phenoxyacetic class herbicide is 2,4-D.

In a preferred embodiment, the phenoxyacetic class herbicide is MCPA.

In an embodiment, pyridine class herbicide is selected from the group consisting of triclopyr, aminopyralid, cliodinate, clopyralid, diflufenican, dithiopyr, florpyrauxifen, flufenican, fluroxypyr, halauxifen, haloxydine, picloram, picolinafen, pyriclor, pyroxsulam, thiazopyr, xyloxadine, and combinations thereof.

In a preferred embodiment, the pyridine class herbicide is triclopyr.

In a preferred embodiment, the pyridine class herbicide is diflufenican.

In a preferred embodiment, the pyridine class herbicide is flufenican.

In a preferred embodiment, the pyridine class herbicide is fluroxypyr.

In a preferred embodiment, the pyridine class herbicide is picloram.

In a preferred embodiment, the pyridine class herbicide is pyroxsulam.

In an embodiment, the cyclohexene oxime class herbicide is selected from the group consisting of clethodim, alloxydim, butroxydim, cloproxydim, cycloxydim, profoxydim, sethoxydim, tepraloxydim, tralkoxydim, and combinations thereof.

In a preferred embodiment, the cyclohexene oxime class herbicide is clethodim.

In an embodiment, the aryloxyphenoxypropionic class herbicide is selected from the group consisting of haloxyfop, chlorazifop, clodinafop, clofop, cyhalofop, diclofop, fenoxaprop, fenoxaprop-P, fenthiaprop, fluazifop, fluazifop-P, haloxyfop-P, isoxapyrifop, kuicaoxi, metamifop, propaquizafop, quizalofop, quizalofop-P, quizalofop-ethyl, quizalofo-P-tefuryl, trifop, and combinations thereof.

In a preferred embodiment, the aryloxyphenoxypropionic class herbicide is haloxyfop or haloxyfop-P.

In a preferred embodiment, the aryloxyphenoxypropionic class herbicide is clodinafop.

In a preferred embodiment, the aryloxyphenoxypropionic class herbicide is fenoxaprop or fenoxaprop-P.

In a preferred embodiment, the aryloxyphenoxypropionic class herbicide is quizalofop or quizalofop-P.

In a preferred embodiment, the aryloxyphenoxypropionic class herbicide is quizalofop-ethyl or quizalofop-P-tefuryl.

In an embodiment, the triazolone class herbicide is selected from the group consisting of carfentrazone, amicarbazone, bencarbazone, flucarbazone, ipfencarbazone, propoxycarbazone, sulfentrazone, thiencarbazone and combinations thereof.

In a preferred embodiment, the triazolone class herbicide is carfentrazone.

In a preferred embodiment, the triazolone class herbicide is amicarbazone.

In a preferred embodiment, the triazolone class herbicide is flucarbazone.

In a preferred embodiment, the triazolone class herbicide is ipfencarbazone.

In a preferred embodiment, the triazolone class herbicide is sulfentrazone.

In an embodiment, the uracil class herbicide is selected from the group consisting of bromacil, isocil, lenacil, terbacil, benzfendizone, butafenacil, epyrifenacil, flupropacil, saflufenacil, tiafenacil, and combinations thereof.

In a preferred embodiment, the uracil class herbicide is saflufenacil.

In an embodiment, the present invention provides a combination for controlling the growth of undesirable vegetation, said combination comprising glufosinate, salts or esters thereof and at least two herbicides, wherein the weight ratio of glufosinate, salts or esters thereof and the at least two herbicides ranges from 1:100:100 to 100:1:1.

In an embodiment, the present invention provides a combination for controlling the growth of undesirable vegetation, said combination comprising L-glufosinate, salts or esters thereof and at least two herbicides, wherein the weight ratio of L-glufosinate, salts or esters thereof and the at least two herbicides ranges from 1:100:100 to 100:1:1.

In an embodiment, the present invention provides a combination for controlling the growth of undesirable vegetation, said combination comprising glufosinate, salts or esters thereof and at least two herbicides, wherein the weight ratio of glufosinate, salts or esters thereof and the at least two herbicides ranges from 1:75:75 to 75:1:1.

In an embodiment, preferably, the weight ratio of glufosinate, salts or esters thereof and the at least two herbicides ranges from 1:50:50 to 50:1:1.

More preferably, the weight ratio between glufosinate, salts or esters thereof and the at least two herbicides ranges from 1:25:25 to 25:1:1, more preferably 1:10:10 to 10:1:1.

In a preferred embodiment, the weight ratio between glufosinate, salts or esters thereof and the at least two herbicides ranges from 1:5:5 to 5:1:1, even more preferably 1:2:2 to 2:1:1.

In an embodiment, the present invention provides a combination for controlling the growth of undesirable vegetation, said combination comprising L-glufosinate, salts or esters thereof and at least two herbicides, wherein the weight ratio of L-glufosinate, salts or esters thereof and the at least two herbicides ranges from 1:75:75 to 75:1:1.

In an embodiment, preferably, the weight ratio of L-glufosinate, salts or esters thereof and the at least two herbicides ranges from 1:50:50 to 50:1:1.

More preferably, the weight ratio between L-glufosinate, salts or esters thereof and the at least two herbicides ranges from 1:25:25 to 25:1:1, more preferably 1:10:10 to 10:1:1.

In a preferred embodiment, the weight ratio between L-glufosinate, salts or esters thereof and the at least two herbicides ranges from 1:5:5 to 5:1:1.

In an embodiment, the present invention provides a combination for controlling the growth of undesirable vegetation, said combination comprising glufosinate, salts or esters thereof and at least two herbicides, wherein the weight ratio of glufosinate, salts or esters thereof and one of the two herbicides ranges from 1:100 to 100:1.

Preferably, the weight ratio of glufosinate, salts or esters thereof and one of the two herbicides ranges from 1:75 to 75:1, more preferably 1:50 to 50:1 and even more preferably 1:25 to 25:1.

In a yet another preferred embodiment, the weight ratio of glufosinate, salts or esters thereof and one of the two herbicides ranges from 1:10 to 10:1, more preferably 1:5 to 5:1 and even more preferably 1:2 to 2:1.

In an embodiment, the present invention provides a combination for controlling the growth of undesirable vegetation, said combination comprising L-glufosinate, salts or esters thereof and at least two herbicides, wherein the weight ratio of L-glufosinate, salts or esters thereof and one of the two herbicides ranges from 1:100 to 100:1.

Preferably, the weight ratio of L-glufosinate, salts or esters thereof and one of the two herbicides ranges from 1:75 to 75:1, more preferably 1:50 to 50:1 and even more preferably 1:25 to 25:1.

In a yet another preferred embodiment, the weight ratio of L-glufosinate, salts or esters thereof and one of the two herbicides ranges from 1:10 to 10:1, more preferably 1:5 to 5:1.

According to an embodiment, the combinations of the present invention are illustrated below in Table 1.

TABLE 1
Exemplary combinations of glufosinate, salts or esters thereof or L-glufosinate, salts
or esters thereof with at least two herbicides

| | | | Ratio of Herbicide1: | |
|---|---|---|---|---|
| | | | Herbicide 2 in | |
| | | | combination and | Ratio of Herbicide2: |
| | | | Herbicide 1:Herbicide | Herbicide 3 in |
| Herbicide 1 | Herbicide 2 | Herbicide 3 | 3 in combination | combination |
| glufosinate, salts | nitrophenyl | nitrophenyl ether | 100:1 to 1:100, | 100:1 to 1:100, |
| or esters thereof | ether herbicide | herbicide different | preferably 1:75 to 75:1, | preferably 1:75 to 75:1, |
| or L-glufosinate, | | from component 1 | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | nitrophenyl | imidazolinone | 100:1 to 1:100, | 100:1 to 1:100, |
| or esters thereof | ether herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | nitrophenyl | organophosphorous | 100:1 to 1:100, | 100:1 to 1:100, |
| or esters thereof | ether herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | nitrophenyl | dicarboximide | 100:1 to 1:100, | 100:1 to 1:100, |
| or esters thereof | ether herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | nitrophenyl | phenoxyacetic | 100:1 to 1:100, | 100:1 to 1:100, |
| or esters thereof | ether herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | nitrophenyl | pyridine herbicide | 100:1 to 1:100, | 100:1 to 1:100, |
| or esters thereof | ether herbicide | | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | nitrophenyl | cyclohexene | 100:1 to 1:100, | 100:1 to 1:100, |
| or esters thereof | ether herbicide | oxime herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | nitrophenyl | aryloxyphenoxypro- | 100:1 to 1:100, | 100:1 to 1:100, |
| or esters thereof | ether herbicide | pionic herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | nitrophenyl | triazolone | 100:1 to 1:100, | 100:1 to 1:100, |
| or esters thereof | ether herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | nitrophenyl | uracil herbicide | 100:1 to 1:100, | 100:1 to 1:100, |
| or esters thereof | ether herbicide | | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | imidazolinone | nitrophenyl ether | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | imidazolinone | imidazolinone | 100:1 to 1:100, | 100:1 to 1:100, |
| or esters thereof | herbicide | herbicide different | preferably 1:75 to 75:1, | preferably 1:75 to 75:1, |
| or L-glufosinate, | | from component 1 | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | imidazolinone | organophosphorous | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | imidazolinone | dicarboximide | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | imidazolinone | phenoxyacetic | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | imidazolinone | pyridine herbicide | 100:1 to 1:100, | 100:1 to 1:100, |
| or esters thereof | herbicide | | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | imidazolinone | cyclohexene | 100:1 to 1:100, | 100:1 to 1:100, |
| or esters thereof | herbicide | oxime herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | imidazolinone | aryloxyphenoxypro- | 100:1 to 1:100, | 100:1 to 1:100, |
| or esters thereof | herbicide | pionic herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | imidazolinone | triazolone | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | imidazolinone | uracil herbicide | 100:1 to 1:100, | 100:1 to 1:100, |
| or esters thereof | herbicide | | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | organophosphorous | nitrophenyl ether | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | organophosphorous | imidazolinone | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | organophosphorous | organophosphorous | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | different from | 50:1, even more | 50:1, even more |
| thereof | | component 1 | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | organophosphorous | dicarboximide | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | organophosphorous | phenoxyacetic | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | organophosphorous | pyridine herbicide | 100:1 to 1:100, | 100:1 to 1:100, |
| or esters thereof | herbicide | | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | organophosphorous | cyclohexene | 100:1 to 1:100, | 100:1 to 1:100, |
| or esters thereof | herbicide | oxime herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | organophosphorous | aryloxyphenoxy- | 100:1 to 1:100, | 100:1 to 1:100, |
| or esters thereof | herbicide | propionic herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | organophosphorous | triazolone | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | organophosphorous | uracil herbicide | 100:1 to 1:100, | 100:1 to 1:100, |
| or esters thereof | herbicide | | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | dicarboximide | nitrophenyl ether | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | dicarboximide | imidazolinone | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | dicarboximide | organophosphorous | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | dicarboximide | dicarboximide | 100:1 to 1:100, | 100:1 to 1:100, |
| or esters thereof | herbicide | herbicide different | preferably 1:75 to 75:1, | preferably 1:75 to 75:1, |
| or L-glufosinate, | | from component 1 | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | dicarboximide | phenoxyacetic | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | dicarboximide | pyridine herbicide | 100:1 to 1:100, | 100:1 to 1:100, |
| or esters thereof | herbicide | | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | dicarboximide | cyclohexene | 100:1 to 1:100, | 100:1 to 1:100, |
| or esters thereof | herbicide | oxime herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | dicarboximide | aryloxyphenoxypro- | 100:1 to 1:100, | 100:1 to 1:100, |
| or esters thereof | herbicide | pionic herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | dicarboximide | triazolone | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | dicarboximide | uracil herbicide | 100:1 to 1:100, | 100:1 to 1:100, |
| or esters thereof | herbicide | | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | phenoxyacetic | nitrophenyl ether | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | phenoxyacetic | imidazolinone | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | phenoxyacetic | organophosphorous | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | phenoxyacetic | dicarboximide | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | phenoxyacetic | phenoxyacetic | 100:1 to 1:100, | 100:1 to 1:100, |
| or esters thereof | herbicide | herbicide different | preferably 1:75 to 75:1, | preferably 1:75 to 75:1, |
| or L-glufosinate, | | from component 1 | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | phenoxyacetic | pyridine herbicide | 100:1 to 1:100, | 100:1 to 1:100, |
| or esters thereof | herbicide | | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | phenoxyacetic | cyclohexene | 100:1 to 1:100, | 100:1 to 1:100, |
| or esters thereof | herbicide | oxime herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | phenoxyacetic | aryloxyphenoxypro- | 100:1 to 1:100, | 100:1 to 1:100, |
| or esters thereof | herbicide | pionic herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | phenoxyacetic | triazolone | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | phenoxyacetic | uracil herbicide | 100:1 to 1:100, | 100:1 to 1:100, |
| or esters thereof | herbicide | | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | pyridine | nitrophenyl ether | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | pyridine | imidazolinone | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | pyridine | organophosphorous | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | pyridine | dicarboximide | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | pyridine | phenoxyacetic | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | pyridine | pyridine herbicide | 100:1 to 1:100, | 100:1 to 1:100, |
| or esters thereof | herbicide | different from | preferably 1:75 to 75:1, | preferably 1:75 to 75:1, |
| or L-glufosinate, | | component 1 | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | pyridine | cyclohexene | 100:1 to 1:100, | 100:1 to 1:100, |
| or esters thereof | herbicide | oxime herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | pyridine | aryloxyphenoxypro- | 100:1 to 1:100, | 100:1 to 1:100, |
| or esters thereof | herbicide | pionic herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | pyridine | triazolone | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | pyridine | uracil herbicide | 100:1 to 1:100, | 100:1 to 1:100, |
| or esters thereof | herbicide | | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | cyclohexene | nitrophenyl ether | 100:1 to 1:100, | 100:1 to 1:100, |
| or esters thereof | oxime | herbicide | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | cyclohexene | imidazolinone | 100:1 to 1:100, | 100:1 to 1:100, |
| or esters thereof | oxime | herbicide | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | cyclohexene | organophosphorous | 100:1 to 1:100, | 100:1 to 1:100, |
| or esters thereof | oxime | herbicide | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | cyclohexene | dicarboximide | 100:1 to 1:100, | 100:1 to 1:100, |
| or esters thereof | oxime | herbicide | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | cyclohexene | phenoxyacetic | 100:1 to 1:100, | 100:1 to 1:100, |
| or esters thereof | oxime | herbicide | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | cyclohexene | pyridine herbicide | 100:1 to 1:100, | 100:1 to 1:100, |
| or esters thereof | oxime | | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | cyclohexene | cyclohexene | 100:1 to 1:100, | 100:1 to 1:100, |
| or esters thereof | oxime | oxime herbicide | preferably 1:75 to 75:1, | preferably 1:75 to 75:1, |
| or L-glufosinate, | herbicide | different from | more preferably 1:50 to | more preferably 1:50 to |
| salts or esters | | component 1 | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | cyclohexene | aryloxyphenoxypro- | 100:1 to 1:100, | 100:1 to 1:100, |
| or esters thereof | oxime | pionic herbicide | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | cyclohexene | triazolone | 100:1 to 1:100, | 100:1 to 1:100, |
| or esters thereof | oxime | herbicide | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | cyclohexene | uracil herbicide | 100:1 to 1:100, | 100:1 to 1:100, |
| or esters | oxime | | preferably 1:75 to 75:1, | preferably 1:75 to 75:1, |
| thereofor L- | herbicide | | more preferably 1:50 to | more preferably 1:50 to |
| glufosinate, salts | | | 50:1, even more | 50:1, even more |
| or esters thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | aryloxyphenoxy- | nitrophenyl ether | 100:1 to 1:100, | 100:1 to 1:100, |
| or esters thereof | propionic | herbicide | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | aryloxyphenoxy- | imidazolinone | 100:1 to 1:100, | 100:1 to 1:100, |
| or esters thereof | propionic | herbicide | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | aryloxyphenoxy- | organophosphorous | 100:1 to 1:100, | 100:1 to 1:100, |
| or esters thereof | propionic | herbicide | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | aryloxyphenoxy- | dicarboximide | 100:1 to 1:100, | 100:1 to 1:100, |
| or esters thereof | propionic | herbicide | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | aryloxyphenoxy- | phenoxyacetic | 100:1 to 1:100, | 100:1 to 1:100, |
| or esters thereof | propionic | herbicide | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | aryloxyphenoxy- | pyridine herbicide | 100:1 to 1:100, | 100:1 to 1:100, |
| or esters thereof | propionic | | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | aryloxyphenoxy- | cyclohexene | 100:1 to 1:100, | 100:1 to 1:100, |
| or esters thereof | propionic | oxime herbicide | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | aryloxyphenoxy- | aryloxyphenoxypro- | 100:1 to 1:100, | 100:1 to 1:100, |
| or esters thereof | propionic | pionic herbicide | preferably 1:75 to 75:1, | preferably 1:75 to 75:1, |
| or L-glufosinate, | herbicide | | more preferably 1:50 to | more preferably 1:50 to |
| salts or esters | | different from | 50:1, even more | 50:1, even more |
| thereof | | component 1 | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | aryloxyphenoxy- | triazolone | 100:1 to 1:100, | 100:1 to 1:100, |
| or esters thereof | propionic | herbicide | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | aryloxyphenoxy- | uracil herbicide | 100:1 to 1:100, | 100:1 to 1:100, |
| or esters thereof | propionic | | preferably 1:75 to 75:1, | preferably 1:75 to 75:1, |
| or L-glufosinate, | herbicide | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | triazolone | nitrophenyl ether | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | triazolone | imidazolinone | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | triazolone | organophosphorous | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | triazolone | dicarboximide | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | triazolone | phenoxyacetic | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | triazolone | pyridine herbicide | 100:1 to 1:100, | 100:1 to 1:100, |
| or esters thereof | herbicide | | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | triazolone | cyclohexene | 100:1 to 1:100, | 100:1 to 1:100, |
| or esters thereof | herbicide | oxime herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | triazolone | aryloxyphenoxypro- | 100:1 to 1:100, | 100:1 to 1:100, |
| or esters thereof | herbicide | pionic herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | triazolone | triazolone | 100:1 to 1:100, | 100:1 to 1:100, |
| or esters thereof | herbicide | herbicide different | preferably 1:75 to 75:1, | preferably 1:75 to 75:1, |
| or L-glufosinate, | | from component 1 | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | triazolone | uracil herbicide | 100:1 to 1:100, | 100:1 to 1:100, |
| or esters thereof | herbicide | | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | uracil | nitrophenyl ether | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | uracil | imidazolinone | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | uracil | organophosphorous | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | uracil | dicarboximide | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | uracil | phenoxyacetic | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | uracil | pyridine herbicide | 100:1 to 1:100, | 100:1 to 1:100, |
| or esters thereof | herbicide | | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | uracil | cyclohexene | 100:1 to 1:100, | 100:1 to 1:100, |
| or esters thereof | herbicide | oxime herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | uracil | aryloxyphenoxypro- | 100:1 to 1:100, | 100:1 to 1:100, |
| or esters thereof | herbicide | pionic herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | uracil | triazolone | 100:1 to 1:100, | 100:1 to 1:100, |
| or esters thereof | herbicide | herbicide | preferably 1:75 to 75:1, | preferably 1:75 to 75:1, |
| or L-glufosinate, | | | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |
| glufosinate, salts | uracil | uracil herbicide | 100:1 to 1:100, | 100:1 to 1:100, |
| or esters thereof | herbicide | different from | preferably 1:75 to 75:1, | preferably 1:75 to 75:1, |
| or L-glufosinate, | | component 1 | more preferably 1:50 to | more preferably 1:50 to |
| salts or esters | | | 50:1, even more | 50:1, even more |
| thereof | | | preferably 1:25 to 25:1, | preferably 1:25 to 25:1, |
| | | | even more preferably | even more preferably |
| | | | 1:10 to 10:1 and most | 1:10 to 10:1 and most |
| | | | preferably 1:5 to 5:1. | preferably 1:5 to 5:1. |

Preferably, the following exemplary combinations of the invention as illustrated in Table 2 were synergistic:

TABLE 2

| | | | Ratio of Herbicide | |
|---|---|---|---|---|
| | | | 1:Herbicide 2 in | |
| | | | combination and | Ratio of Herbicide |
| | | | Herbicide 1:Herbicide 3 | 2:Herbicide 3 in |
| Herbicide 1 | Herbicide 2 | Herbicide 3 | in combination | combination |
| Glufosinate, | Oxyfluorfen | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Glyphosate | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1 even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Oxyfluorfen | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Glyphosate | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Haloxyfop | 100:1 to 1:100, preferably | 100:1 to 1:100, preferably |
| salts or esters | | | to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Acifluorfen | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| | | | to 25:1, even more | to 25:1, even more |
| salts or esters | | | preferably 1:10 to 10:1 and | preferably 1:10 to 10:1 and |
| thereof | | | most preferably 1:5 to 5:1. | most preferably 1:5 to 5:1. |
| Glufosinate, | Fomesafen | Glyphosate | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fomesafen | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Glyphosate | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Aclonifen | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Glyphosate | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazethapyr | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Glyphosate | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazamox | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Imazapic | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Glyphosate | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Imazapyr | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10: 1 and | preferably 1:10 to 10:1 and |
| | | | most preferably 1:5 to 5:1. | most preferably 1:5 to 5:1. |
| Glufosinate, | Glyphosate | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Glyphosate | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flumioxazin | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | 2,4-D | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | MCPA | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Diflufenican | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flufenican | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Fluroxypyr | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Picloram | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Picloram | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Pyroxsulam | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Pyroxsulam | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clethodim | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Clodinafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Haloxyfop | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Clodinafop | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Quizalafop | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Quizalafop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Carfentrazone | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Amicarbazone | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Flucarbazone | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Sulfentrazone | Saflufenacil | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Acifluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Fomesafen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Aclonifen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Imazamox | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Imazethapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Imazapyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Oxyfluorfen | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Flumioxazin | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | 2,4-D | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | MCPA | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Diflufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Flufenican | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Fluroxypyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Triclopyr | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Clethodim | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Haloxyfop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Fenoxaprop | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Carfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Amicarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Ipfencarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Flucarbazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |
| Glufosinate, | Saflufenacil | Sulfentrazone | 100:1 to 1:100, preferably | 100:1 to 1:100, preferably |
| salts or esters | | | 1:75 to 75:1, more | 1:75 to 75:1, more |
| thereof or L- | | | preferably 1:50 to 50:1, | preferably 1:50 to 50:1, |
| glufosinate, | | | even more preferably 1:25 | even more preferably 1:25 |
| salts or esters | | | to 25:1, even more | to 25:1, even more |
| thereof | | | preferably 1:10 to 10:1 and | preferably 1:10 to 10:1 and |
| | | | most preferably 1:5 to 5:1. | most preferably 1:5 to 5:1. |

In an embodiment, the combinations of the present invention comprise of glufosinate, salts or esters thereof, or L-glufosinate, salts or esters thereof, and at least two herbicides, wherein glufosinate, salts or esters thereof is present in an amount in the range of 100 to 400 g ai/L, preferably 180 to 380 g ai/L, more preferably 250 to 350 g ai/L. In a preferred embodiment, the formulation comprises 280 g ai/L of glufosinate, salts or esters thereof.

In an embodiment, the combinations of the present invention comprise of glufosinate, salts or esters thereof, or L-glufosinate, salts or esters thereof, and at least two herbicides, wherein the at least one herbicide is selected from nitrophenyl ether class of herbicides, and wherein the nitrophenyl ether class of herbicides is present in the formulation in an amount in the range of 100 to 400 g ai/L, preferably 140 to 340 g ai/L, more preferably 200 to 250 g ai/L.

In an embodiment, the combinations of the present invention comprise of glufosinate, salts or esters thereof, or L-glufosinate, salts or esters thereof, and at least two herbicides, wherein the at least one herbicide is selected from imidazoline class of herbicides, and wherein the imidazoline class of herbicides is present in the formulation in an amount in the range of 10 to 250 g ai/L, preferably 50-200 g ai/L, more preferably 75-125 g ai/L.

In an embodiment, the combinations of the present invention comprise of glufosinate, salts or esters thereof, or L-glufosinate, salts or esters thereof, and at least two herbicides, wherein the at least one herbicide is selected from imidazoline class of herbicides, and wherein the imidazoline class of herbicides is present in the formulation in an amount in the range of 100 to 1000 g ai/L, preferably 100-800 g ai/L.

In an embodiment, the combinations of the present invention comprise of glufosinate, salts or esters thereof, or L-glufosinate, salts or esters thereof, and at least two herbicides, wherein the at least one herbicide is selected from organophosphorous class of herbicides, and wherein the organophosphorous class of herbicides is present in the formulation in an amount in the range of 200 to 1000 g ai/L, preferably 400 to 800 g ai/L, more preferably 500-700 g ai/L.

In an embodiment, the combinations of the present invention comprise of glufosinate, salts or esters thereof, or L-glufosinate, salts or esters thereof, and at least two herbicides, wherein the at least one herbicide is selected from dicarboximide class of herbicides, and wherein the dicarboximide class of herbicides is present in the formulation in an amount in the range of 200-800 g ai/L, preferably 300 to 700 g ai/L, more preferably 400-600 g ai/L.

In an embodiment, the combinations of the present invention comprise of glufosinate, salts or esters thereof, or L-glufosinate, salts or esters thereof, and at least two herbicides, wherein the at least one herbicide is selected from phenoxyacetic class of herbicides, and wherein the phenoxyacetic class of herbicides is present in the formulation in an amount in the range of 200 to 1200 g ai/L, preferably 400-1000 g ai/L, more preferably 450-850 g ai/L.

In an embodiment, the combinations of the present invention comprise of glufosinate, salts or esters thereof, or L-glufosinate, salts or esters thereof, and at least two herbicides, wherein the at least one herbicide is selected from phenoxyacetic class of herbicides, and wherein the phenoxyacetic class of herbicides is present in the formulation in an amount in the range of 400 to 1200 g ai/L, preferably 600-1000 g ai/L, more preferably 750-850 g ai/L.

In an embodiment, the combinations of the present invention comprise of glufosinate, salts or esters thereof, or L-glufosinate, salts or esters thereof, and at least two herbicides, wherein the at least one herbicide is selected from pyridine class of herbicides, and wherein the pyridine class of herbicides is present in the formulation in an amount in the range of 300-1000 g ai/L, preferably 400 to 900 g ai/L, more preferably 400 to 750 g ai/L.

In an embodiment, the combinations of the present invention comprise of glufosinate, salts or esters thereof, or L-glufosinate, salts or esters thereof, and at least two herbicides, wherein the at least one herbicide is selected from pyridine class of herbicides, and wherein the pyridine class of herbicides is present in the formulation in an amount in the range of 300-1000 g ai/L, preferably 400 to 900 g ai/L, more preferably 500 to 750 g ai/L.

In an embodiment, the combinations of the present invention comprise of glufosinate, salts or esters thereof, or L-glufosinate, salts or esters thereof, and at least two herbicides, wherein the at least one herbicide is selected from cyclohexene oxime class of herbicides, and wherein the cyclohexene oxime class of herbicides is present in the formulation in an amount in the range of 100-400 g ai/L, preferably 150 to 350 g ai/L, preferably 200-300 g ai/L.

In an embodiment, the combinations of the present invention comprise of glufosinate, salts or esters thereof, or L-glufosinate, salts or esters thereof, and at least two herbicides, wherein the at least one herbicide is selected from aryloxyphenoxypropionic class of herbicides, and wherein the aryloxyphenoxypropionic class of herbicides is present in the formulation in an amount in the range of 1 to 250 g ai/L, preferably 10-200 g ai/L and more preferably 50-150 g ai/L.

In an embodiment, the combinations of the present invention comprise of glufosinate, salts or esters thereof, or L-glufosinate, salts or esters thereof, and at least two herbicides, wherein the at least one herbicide is selected from triazolone class of herbicides, and wherein the triazolone class of herbicides is present in the formulation in an amount in the range of 100-800 g ai/L, preferably 200 to 600 g ai/L, more preferably 300 to 500 g ai/L.

In an embodiment, the combinations of the present invention comprise of glufosinate, salts or esters thereof, or L-glufosinate, salts or esters thereof, and at least two herbicides, wherein the at least one herbicide is selected from uracil class of herbicides, and wherein the uracil class of herbicides is present in the formulation in an amount in the range of 1-1000 g ai/L, preferably 50 to 800 g ai/L.

More surprisingly, it was found that this combination of glufosinate, salts or esters thereof or L-glufosinate, salts or esters thereof, an herbicide selected from the imidazolinone class of herbicides, and an herbicide selected from the triazolone class of herbicides, acted in a synergistic manner in controlling a range of weeds. The degree of synergistic enhancement in efficacy of the above combination towards control a range of weeds was unpredictable and unexpected.

Therefore, in an embodiment, the present invention provides a combination for controlling the growth of undesirable vegetation and weeds, wherein the combination comprises glufosinate, salts or esters thereof or L-glufosinate, salts or esters thereof; a herbicide selected from the imidazolinone class of herbicides, and a herbicide selected from the triazolone class of herbicides.

In an embodiment, the present invention provides a combination for controlling the growth of undesirable vegetation and weeds, wherein the combination comprises glufosinate, salts or esters thereof or L-glufosinate, salts or esters thereof, and at least two herbicides, wherein the herbicide selected from the imidazolinone class of herbicides is imazethapyr, and wherein the herbicide selected from the triazolone class of herbicides is carfentrazone.

In another embodiment, the present invention provides a combination of glufosinate, salts or esters thereof or L-glufosinate, salts or esters thereof, imazethapyr and carfentrazone, for controlling the growth of undesirable vegetation and weeds, wherein the weight ratio of glufosinate, salts or esters thereof or L-glufosinate, salts or esters thereof, imazethapyr, and carfentrazone ranges from 1:100:100 to 100:1:1. Preferably, the weight ratio of glufosinate, salts or esters thereof or L-glufosinate, salts or esters thereof, imazethapyr, and carfentrazone ranges from 1:75:75 to 75:1:1, more preferably 1:50:50 to 50:1:1, even more preferably from 1:25:25 to 25:1:1.

In an embodiment, the weight ratio of glufosinate, salts or esters thereof, imazethapyr, and carfentrazone ranges from 1:10:10 to 10:1:1, preferably from 1:5:5 to 5:1:1, more preferably from 1:2:2 to 2:1:1.

In an embodiment, the present invention provides a combination for controlling the growth of undesirable vegetation and weeds, wherein the combination comprises glufosinate, salts or esters thereof or L-glufosinate, salts or esters thereof; an herbicide selected from the phenoxyacetic class of herbicides, and an herbicide selected from the uracil class of herbicides.

In an embodiment, the present invention provides a combination for controlling the growth of undesirable vegetation and weeds, wherein the combination comprises glufosinate, salts or esters thereof or L-glufosinate, salts or esters thereof, and at least two herbicides, wherein the herbicide selected from the phenoxyacetic class of herbicides is 2,4-D, and wherein the herbicide selected from the uracil class of herbicides is saflufenacil.

In another embodiment, the present invention provides a combination of glufosinate, salts or esters thereof or L-glufosinate, salts or esters thereof, 2,4-D and saflufenacil, for controlling the growth of undesirable vegetation and weeds, wherein the weight ratio of glufosinate, salts or esters thereof or L-glufosinate, salts or esters thereof, 2,4D, and saflufenacil ranges from 1:100:100 to 100:1:1. Preferably, the weight ratio of glufosinate, salts or esters thereof, or L-glufosinate, salts or esters thereof, 2,4-D, and saflufenacil ranges from 1:75:75 to 75:1:1, more preferably 1:50:50 to 50:1:1, even more preferably from 1:25:25 to 25:1:1.

In an embodiment, the weight ratio of glufosinate, salts or esters thereof, or L-glufosinate, salts or esters thereof, 2,4D, and saflufenacil ranges from 1:10:10 to 10:1:1, preferably from 1:5:5 to 5:1:1.

In an embodiment, the present invention provides a combination for controlling the growth of undesirable vegetation and weeds, wherein the combination comprises glufosinate, salts or esters thereof or L-glufosinate, salts or esters thereof; an herbicide selected from the pyridine class of herbicides, and an herbicide selected from the uracil class of herbicides.

In an embodiment, the present invention provides a combination for controlling the growth of undesirable vegetation and weeds, wherein the combination comprises glufosinate, salts or esters thereof or L-glufosinate, salts or esters thereof, and at least two herbicides, wherein the herbicide selected from the pyridine class of herbicides is triclopyr, and wherein the herbicide selected from the uracil class of herbicides is saflufenacil.

In another embodiment, the present invention provides a combination of glufosinate, salts or esters thereof or L-glufosinate, salts or esters thereof, triclopyr and saflufenacil, for controlling the growth of undesirable vegetation and weeds, wherein the weight ratio of glufosinate, salts or esters thereof or L-glufosinate, salts or esters thereof, triclopyr, and saflufenacil ranges from 1:100:100 to 100:1:1. Preferably, the weight ratio of glufosinate, salts or esters thereof, or L-glufosinate, salts or esters thereof, triclopyr, and saflufenacil ranges from 1:75:75 to 75:1:1, more preferably 1:50:50 to 50:1:1, even more preferably from 1:25:25 to 25:1:1.

In an embodiment, the weight ratio of glufosinate, salts or esters thereof, or L-glufosinate, salts or esters thereof, triclopyr, and saflufenacil ranges from 1:10:10 to 10:1:1, preferably from 1:5:5 to 5:1:1.

in an embodiment, the present invention provides a combination for controlling the growth of undesirable vegetation and weeds, wherein the combination comprises glufosinate, salts or esters thereof or L-glufosinate, salts or esters thereof; and two herbicides selected from the imidazolinone class of herbicides.

In an embodiment, the present invention provides a combination for controlling the growth of undesirable vegetation and weeds, wherein the combination comprises glufosinate, salts or esters thereof or L-glufosinate, salts or esters thereof, and at least two herbicides of imidazolinones class of herbicides, wherein the two herbicides selected from the imidazolinone class of herbicides are imazapic and imazapyr.

In another embodiment, the present invention provides a combination of glufosinate, salts or esters thereof or L-glufosinate, salts or esters thereof, imazapic and imazapyr, for controlling the growth of undesirable vegetation and weeds, wherein the weight ratio of glufosinate, salts or esters thereof or L-glufosinate, salts or esters thereof, imazapic, and imazapyr ranges from 1:100:100 to 100:1:1. Preferably, the weight ratio of glufosinate, salts or esters thereof or L-glufosinate, salts or esters thereof, imazapic, and imazapyr ranges from 1:75:75 to 75:1:1, more preferably 1:50:50 to 50:1:1, even more preferably from 1:25:25 to 25:1:1.

In an embodiment, the weight ratio of glufosinate, salts or esters thereof, imazapic, and imazapyr ranges from 1:10:10 to 10:1:1, preferably from 1:5:5 to 5:1:1.

In an embodiment, the present invention provides a composition comprising the combinations of the present invention along with at least one agrochemically suitable excipient.

In an embodiment, the present invention provides an herbicidal composition comprising glufosinate, salts or esters thereof, at least two herbicides selected from:
(a) nitrophenyl ether class of herbicides;
(b) imidazolinone class of herbicides;
(c) organophosphorous class of herbicides;
(d) dicarboximide class of herbicides;
(e) phenoxyacetic class of herbicides;
(f) pyridine class of herbicides;
(g) cyclohexene oxime class of herbicides;
(h) aryloxyphenoxypropionic class of herbicides;
(i) triazolone class of herbicides;
(j) uracil class of herbicides,
   and at least one agrochemically suitable excipient.

In an embodiment, the present invention provides an herbicidal composition comprising L-glufosinate, salts or esters thereof, at least two herbicides selected from:
(a) nitrophenyl ether class of herbicides;
(b) imidazolinone class of herbicides;
(c) organophosphorous class of herbicides;
(d) dicarboximide class of herbicides;
(e) phenoxyacetic class of herbicides;
(f) pyridine class of herbicides;
(g) cyclohexene oxime class of herbicides;
(h) aryloxyphenoxypropionic class of herbicides;
(i) triazolone class of herbicides;
(j) uracil class of herbicides,
   and at least one agrochemically suitable excipient.

In an embodiment, the said composition is a tank-mix composition.

In an embodiment, the said composition comprises glufosinate, salts or esters thereof, or L-glufosinate, salts or esters thereof, and at least two herbicides in a synergistic combination, wherein the weight ratio of glufosinate, salts or esters thereof, or L-glufosinate, salts or esters thereof, and the at least two herbicides is 1:100:100 to 100:1:1, preferably 1:75:75 to 75:1:1, more preferably 1:50:50 to 50:1:1 and even more preferably 1:25:25 to 25:1:1.

In an embodiment, the said composition comprises glufosinate, salts or esters thereof, or L-glufosinate, salts or esters thereof, and at least two herbicides in a synergistic combination, wherein the weight ratio of glufosinate, salts or esters thereof, or L-glufosinate, salts or esters thereof, and one of the two herbicides is 1:100 to 100:1, preferably 1:75 to 75:1, more preferably 1:50 to 50:1 and even more preferably 1:25 to 25:1.

In an embodiment, the said composition comprises glufosinate, salts or esters thereof, or L-glufosinate, salts or esters thereof, and at least two herbicides in a synergistic combination, wherein the weight ratio of the two herbicides is 1:100 to 100:1, preferably 1:75 to 75:1, more preferably 1:50 to 50:1 and even more preferably 1:25 to 25:1.

In an embodiment, the compositions of the present invention additionally comprise one or more agrochemically suitable excipients such as adjuvants, additives, or carriers along with other ingredients such as surfactants.

The agrochemically suitable excipient may be any one or a combination of adjuvants, co-solvents, surfactants, colorants, dispersants, diluents, emulsifiers, fillers, thickening agents, antifreeze agents, freezing agents, biocides, anti-foaming agents, stabilizers, wetting agents or a mixture thereof which may be optionally added to the compositions of the present invention.

The surfactants may be selected from non-ionic, anionic or cationic surfactants.

Examples of nonionic surfactants include polyarylphenol polyethoxyethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C8-C22 alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol and mixtures thereof.

Examples of anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C12-C15 alkanols or polyalkoxylated C12-C15 alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates.

Cationic surfactants include alkanol amides of C8-C18 fatty acids and C8-C18 fatty amine polyalkoxylates, C10-C18 alkyldimethylbenzylammonium chlorides, coconut alkyldimethylaminoacetic acids, and phosphate esters of C8-C18 fatty amine polyalkoxylates.

Emulsifiers which can be advantageously employed herein can be readily determined by those skilled in the art and include various non-ionic, anionic, cationic and amphoteric emulsifiers, or a blend of two or more emulsifiers. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether.

In an embodiment, colorants may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

Another embodiment involves addition of a thickening agent or binder which may be selected from but not limited to molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol and polyglycols.

In another embodiment, antifreeze agent(s) added to the composition may be alcohols selected from the group comprising of but not limited to ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol or octaglycerol may also be used.

According to an embodiment, biocides may be selected from benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl.

According to an embodiment, antifoaming agent may be selected from Polydimethoxysiloxane, polydimethylsiloxane, Alkyl poly acrylates, Castor Oil, Fatty Acids, Fatty Acids Esters, Fatty Acids Sulfate, Fatty Alcohol, Fatty Alcohol Esters, Fatty Alcohol Sulfate, Foot Olive Oil, Mono & Di Glyceride, Paraffin Oil, Paraffin Wax, Poly Propylene Glycol, Silicones Oil, Vegetable & Animal Fats, Vegetable & Animal Fats Sulfate, Vegetable & Animal Oil, Vegetable & Animal Oil Sulfate, Vegetable & Animal Wax, Vegetable & Animal Wax Sulfate, agents based on silicon or magnesium stearate.

Representative organic liquids which can be employed in preparing the emulsifiable concentrates of the present invention are the aromatic liquids such as xylene, propyl benzene fractions, or mixed naphthalene fractions, mineral oils, substituted aromatic organic liquids such as dioctyl phthalate, kerosene, dialkyl amides of various fatty acids, particularly the dimethyl amides of fatty glycols and glycol derivatives such as the n-butyl ether, ethyl ether or methyl ether of diethylene glycol, and the methyl ether of triethylene glycol. Mixtures of two or more organic liquids are also often suitably employed in the preparation of the emulsifiable concentrate. The formulations can also contain other compatible additives, for example, plant growth regulators and other biologically active compounds used in agriculture.

The additives to be used for the formulation include, for example, a solid carrier such as kaolinite, sericite, diatomaceous earth, slaked lime, calcium carbonate, talc, white carbon, kaoline, bentonite, clay, sodium carbonate, sodium bicarbonate, mirabilite, zeolite or starch; a solvent such as water, toluene, xylene, solvent naphtha, dioxane, dimethylsulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenylether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or a salt of alkylnaphthalene sulfonic acid condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, cottonseed oil, soybean oil, rapeseed oil, linseed oil, tung oil or liquid paraffins. These additives may suitably be selected for use alone or in combination as a mixture of two or more of them, so long as the object of the present invention is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be used.

The agrochemical formulation may also comprise one or more antioxidants. Preferably, the agrochemical formulation comprises an antioxidants. Antioxidants are, for example, amino acids (e.g. Glycine, histidine, tyrosine, tryptophan) and derivatives thereof, imidazole and imidazole derivatives (e.g. urocanic acid), peptides, such as, for example, D,L-carnosine, D-carnosine, L-carnosine and derivatives thereof (e.g. anserine), carotenoids, carotenes (e.g. α-carotene, β-carotene, lycopene) and derivatives thereof, lipoic acid and derivatives thereof (e.g. dihydrolipoic acid), aurothioglucose, propylthiouracil and further thio compounds (e.g. thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g. buthionine sulfoximines, homocysteine sulfoximine, buthionine sulfones, penta-, hexa-, heptathionine sulfoximine) in very low tolerated doses (e.g. pmol/kg to pmol/kg), also metal chelating agents (e.g. α-hydroxy fatty acids, EDTA, EGTA, phytic acid, lactoferrin), α-hydroxy acids (e.g. citric acid, lactic acid, malic acid), humic acids, bile acid, bile extracts, gallic esters (e.g. propyl, octyl and dodecyl gallate), flavonoids, catechins, bilirubin, biliverdin and derivatives thereof, unsaturated fatty acids and derivatives thereof (e.g. γ-linolenic acid, linoleic acid, arachidonic acid, oleic acid), folic acid and derivatives thereof, hydroquinone and derivatives thereof (e.g. arbutin), ubiquinone and ubiquinol, and derivatives thereof, vitamin C and derivatives thereof (e.g. ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g. tocopheryl acetate, linoleate, oleate and succinate, tocophereth-5, tocophereth-10, tocophereth-12, tocophereth-18, tocophereth-50, tocophersolan), vitamin A and derivatives (e.g. vitamin A palmitate), the coniferyl benzoate of benzoin resin, rutin, rutinic acid and derivatives thereof, disodium rutinyl disulfate, cinnamic acid and derivatives thereof (e.g. ferulic acid, ethyl ferulate, caffeeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g. selenomethionine), stilbenes and stilbene derivatives (e.g. stilbene oxide, trans-stilbene oxide). According to the invention, suitable derivatives (salts, esters, sugars, nucleotides, nucleosides, peptides and lipids) and mixtures of these specified active ingredients or plant extracts (e.g. teatree oil, rosemary extract and rosemarinic acid) which comprise these antioxidants can be used. In general, mixtures of the aforementioned antioxidants are possible.

According to an embodiment, examples of suitable solvents are water, aromatic solvents (for example Solvesso products, xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

According to an embodiment, suitable surfactants are alkali metal, alkaline earth metal and ammonium salts of lignosulfonic acid, naphthalenesulfonates, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

According to an embodiment, examples of suitable carriers are mineral earths such as silica gels, silicates, talc, kaolin, attaclay, attapulgite, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders, polyvinylpyrrolidone and other solid carriers).

Suitable preservatives are for example 1,2-benzisothiazolin-3-one and/or 2-Methyl-2H-isothiazol-3-one or sodium benzoate or benzoic acid.

In an embodiment, the composition may be in any agriculturally suitable form for storage and application to the ground. The compositions of the present invention may typically be produced by mixing the actives in the composition with an inert carrier, and adding surfactants and other adjuvants and carriers as needed and formulated into solid, or liquid formulations, including but not limited to powders, wettable powders, pellets, tablets, granules, dusts, dry flowables, water-dispersible granules, microcapsules, soluble (liquid) concentrates, suspension concentrates, oil in water emulsion, water in oil emulsion, emulsifiable concentrates, capsule suspensions, ZC formulations, oil dispersions or other known formulation types.

The terms “g ai/L” as used herein denotes the concentration of the respective active ingredient in “grams” present “per litre” of the composition.

In an embodiment, the liquid formulations comprise of glufosinate, salts or esters thereof, and at least two herbicides, wherein glufosinate, salts or esters thereof is present in an amount in the range of 100 to 400 g ai/L, preferably 180 to 380 g ai/L, more preferably 250 to 350 g ai/L. In a preferred embodiment, the formulation comprises 280 g ai/L of glufosinate, salts or esters thereof.

In an embodiment, the liquid formulations comprise of glufosinate, salts or esters thereof, and at least two herbicides, wherein the at least one herbicide is selected from nitrophenyl ether class of herbicides, and wherein the nitrophenyl ether class of herbicides is present in the formulation in an amount in the range of 100 to 400 g ai/L, preferably 140 to 340 g ai/L, more preferably 200 to 250 g ai/L.

In an embodiment, the liquid formulations comprise of glufosinate, salts or esters thereof, and at least two herbicides, wherein the at least one herbicide is selected from imidazoline class of herbicides, and wherein the imidazoline class of herbicides is present in the formulation in an amount in the range of 10 to 250 g ai/L, preferably 50-200 g ai/L, more preferably 75-125 g ai/L.

In an embodiment, the liquid formulations comprise of glufosinate, salts or esters thereof, and at least two herbicides, wherein the at least one herbicide is selected from imidazoline class of herbicides, and wherein the imidazoline class of herbicides is present in the formulation in an amount in the range of 100 to 1000 g ai/L, preferably 100-800 g ai/L.

In an embodiment, the liquid formulations comprise of glufosinate, salts or esters thereof, and at least two herbicides, wherein the at least one herbicide is selected from organophosphorous class of herbicides, and wherein the organophosphorous class of herbicides is present in the formulation in an amount in the range of 200 to 1000 g ai/L, preferably 400 to 800 g ai/L, more preferably 500-700 g ai/L.

In an embodiment, the liquid formulations comprise of glufosinate, salts or esters thereof, and at least two herbicides, wherein the at least one herbicide is selected from dicarboximide class of herbicides, and wherein the dicarboximide class of herbicides is present in the formulation in an amount in the range of 200-800 g ai/L, preferably 300 to 700 g ai/L, more preferably 400-600 g ai/L.

In an embodiment, the liquid formulations comprise of glufosinate, salts or esters thereof, and at least two herbicides, wherein the at least one herbicide is selected from phenoxyacetic class of herbicides, and wherein the phenoxyacetic class of herbicides is present in the formulation in an amount in the range of 200 to 1200 g ai/L, preferably 400-1000 g ai/L, more preferably 450-850 g ai/L.

In an embodiment, the liquid formulations comprise of glufosinate, salts or esters thereof, and at least two herbicides, wherein the at least one herbicide is selected from phenoxyacetic class of herbicides, and wherein the phenoxyacetic class of herbicides is present in the formulation in an amount in the range of 400 to 1200 g ai/L, preferably 600-1000 g ai/L, more preferably 750-850 g ai/L.

In an embodiment, the liquid formulations comprise of glufosinate, salts or esters thereof, and at least two herbicides, wherein the at least one herbicide is selected from pyridine class of herbicides, and wherein the pyridine class of herbicides is present in the formulation in an amount in the range of 300-1000 g ai/L, preferably 400 to 900 g ai/L, more preferably 400 to 750 g ai/L.

In an embodiment, the liquid formulations comprise of glufosinate, salts or esters thereof, and at least two herbicides, wherein the at least one herbicide is selected from pyridine class of herbicides, and wherein the pyridine class of herbicides is present in the formulation in an amount in the range of 300-1000 g ai/L, preferably 400 to 900 g ai/L, more preferably 500 to 750 g ai/L.

In an embodiment, the liquid formulations comprise of glufosinate, salts or esters thereof, and at least two herbicides, wherein the at least one herbicide is selected from cyclohexene oxime class of herbicides, and wherein the cyclohexene oxime class of herbicides is present in the formulation in an amount in the range of 100-400 g ai/L, preferably 150 to 350 g ai/L, preferably 200-300 g ai/L.

In an embodiment, the liquid formulations comprise of glufosinate, salts or esters thereof, and at least two herbicides, wherein the at least one herbicide is selected from aryloxyphenoxypropionic class of herbicides, and wherein the aryloxyphenoxypropionic class of herbicides is present in the formulation in an amount in the range of 1 to 250 g ai/L, preferably 10-200 g ai/L and more preferably 50-150 g ai/L.

In an embodiment, the liquid formulations comprise of glufosinate, salts or esters thereof, and at least two herbicides, wherein the at least one herbicide is selected from triazolone class of herbicides, and wherein the triazolone class of herbicides is present in the formulation in an amount in the range of 100-800 g ai/L, preferably 200 to 600 g ai/L, more preferably 300 to 500 g ai/L.

In an embodiment, the liquid formulations comprise of glufosinate, salts or esters thereof, and at least two herbicides, wherein the at least one herbicide is selected from uracil class of herbicides, and wherein the uracil class of herbicides is present in the formulation in an amount in the range of 1-1000 g ai/L, preferably 50 to 800 g ai/L.

The composition may also be used for treatment of a plant propagation material such as seeds etc.

The compositions of the present invention may be applied in any known ways or conventional methods known to a person skilled in art. Non-limiting examples of such methods are foliar spray, basal barking, stem injection, drill and fill method, axe cut method, cut stump, cut and swab, stem scraper, wick application and so forth. The compositions of the present invention are used in the customary manner, for example by watering, spraying, atomizing, dusting or scattering. Said compositions can be applied to a locus by the use of conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots and by other conventional means known to those skilled in the art.

In an embodiment, the present invention provides a method of controlling the growth of undesirable vegetation, the method comprising treating the locus at which control is desired with combinations or synergistic combinations of the present invention or compositions comprising said combinations.

In an embodiment, the present invention provides a method of controlling the growth of undesirable vegetation at a locus, the method comprising treating the locus with an herbicidal combination or a composition comprising said combination, wherein the combination comprises glufosinate, salts or esters thereof, and at least two herbicides selected from:
a) nitrophenyl ether class of herbicides;
b) imidazolinone class of herbicides;
c) organophosphorous class of herbicides;
d) dicarboximide class of herbicides;
e) phenoxyacetic class of herbicides;
f) pyridine class of herbicides;
g) cyclohexene oxime class of herbicides;
h) aryloxyphenoxypropionic class of herbicides;
i) triazolone class of herbicides; and/or
j) uracil class of herbicides.

In an embodiment, the present invention provides a method of controlling the growth of undesirable vegetation at a locus, the method comprising treating the locus with an herbicidal combination or a composition comprising said combination, wherein the combination comprises comprising L-glufosinate, salts or esters thereof, and at least two herbicides selected from:
a) nitrophenyl ether class of herbicides;
b) imidazolinone class of herbicides;
c) organophosphorous class of herbicides;
d) dicarboximide class of herbicides;
e) phenoxyacetic class of herbicides;
f) pyridine class of herbicides;
g) cyclohexene oxime class of herbicides;
h) aryloxyphenoxypropionic class of herbicides;
i) triazolone class of herbicides; and/or
j) uracil class of herbicides.

In an embodiment, the present invention provides a method of controlling the growth of undesirable vegetation at a locus, the method comprising treating the locus with a synergistic herbicidal combination comprising glufosinate, salts or esters thereof, and at least two herbicides selected from:
k) nitrophenyl ether class of herbicides;
l) imidazolinone class of herbicides;
m) organophosphorous class of herbicides;
n) dicarboximide class of herbicides;
o) phenoxyacetic class of herbicides;
p) pyridine class of herbicides;
q) cyclohexene oxime class of herbicides;
r) aryloxyphenoxypropionic class of herbicides;
s) triazolone class of herbicides;
t) uracil class of herbicides,
or combinations thereof.

In an embodiment, the present invention provides a method of controlling the growth of undesirable vegetation at a locus, the method comprising treating the locus with a synergistic herbicidal combination comprising L-glufosinate, salts or esters thereof, and at least two herbicides selected from:
k) nitrophenyl ether class of herbicides;
l) imidazolinone class of herbicides;
m) organophosphorous class of herbicides;
n) dicarboximide class of herbicides;
o) phenoxyacetic class of herbicides;
p) pyridine class of herbicides;
q) cyclohexene oxime class of herbicides;
r) aryloxyphenoxypropionic class of herbicides;
s) triazolone class of herbicides;
t) uracil class of herbicides,
or combinations thereof.

In an embodiment, the present invention provides a method for increasing yield in a crop by using the combinations of the present invention. Therefore, in an embodiment, the present invention provides a method for increasing yield in a crop by application of a combination or composition comprising—glufosinate, salts or esters thereof, or L-glufosinate, salts or esters thereof, and at least two herbicides selected from:
(a) nitrophenyl ether class of herbicides;
(b) imidazolinone class of herbicides;
(c) organophosphorous class of herbicides;
(d) dicarboximide class of herbicides;
(e) phenoxyacetic class of herbicides;
(f) pyridine class of herbicides;
(g) cyclohexene oxime class of herbicides;
(h) aryloxyphenoxypropionic class of herbicides;
(i) triazolone class of herbicides; and/or
(j) uracil class of herbicides.

In an embodiment, the present invention provides a method for improving the plant health using the combinations of the present invention. Therefore, in an embodiment, the present invention provides a method for improving the plant health by application of a combination or composition comprising—glufosinate, salts or esters thereof, or L-glufosinate, salts or esters thereof, and at least two herbicides selected from:
(a) nitrophenyl ether class of herbicides;
(b) imidazolinone class of herbicides;
(c) organophosphorous class of herbicides;
(d) dicarboximide class of herbicides;
(e) phenoxyacetic class of herbicides;
(f) pyridine class of herbicides;
(g) cyclohexene oxime class of herbicides;
(h) aryloxyphenoxypropionic class of herbicides;
(i) triazolone class of herbicides; and/or
(j) uracil class of herbicides

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, and at least two herbicides, wherein the weight ratio of glufosinate, salts or esters thereof or L-glufosinate, salts or esters thereof, and the at least two herbicides is 1:100:100 to 100:1:1, preferably 1:75:75 to 75:1:1, more preferably 1:50:50 to 50:1:1 and even more preferably 1:25:25 to 25:1:1.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, and at least two herbicides, wherein the weight ratio of glufosinate, salts or esters thereof or L-glufosinate, salts or esters thereof, and one of the two herbicides is 1:100 to 100:1, preferably 1:75 to 75:1, more preferably 1:50 to 50:1 and even more preferably 1:25 to 25:1.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, and at least two herbicides, wherein the weight ratio of the two herbicides is 1:100 to 100:1, preferably 1:75 to 75:1, more preferably 1:50 to 50:1 and even more preferably 1:25 to 25:1.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, a herbicide selected from the imidazolinone class of herbicides, and a herbicide selected from the triazolone class of herbicides.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, a herbicide selected from the imidazolinone class of herbicides, and a herbicide selected from the triazolone class of herbicides, wherein glufosinate, salts or esters thereof, the herbicide selected from the imidazolinone class of herbicides, and the herbicide selected from the triazolone class of herbicides are present in a ratio of 1:100:100 to 100:1:1, more preferably 1:10:10 to 10:1:1.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof; a herbicide selected from the imidazolinone class of herbicides; and a herbicide selected from the triazolone class of herbicides, wherein the imidazolinone class herbicide is imazethapyr and the triazolone class herbicide is carfentrazone.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, imazethapyr and carfentrazone, wherein the weight ratio of glufosinate, salts or esters thereof, imazethapyr and carfentrazone is 1:10:10 to 10:1:1, preferably 1:5:5 to 5:1:1, more preferably 1:2:2 to 2:1:1.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, a herbicide selected from the phenoxyacetic class of herbicides, and a herbicide selected from the uracil class of herbicides.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, a herbicide selected from the phenoxyacetic class of herbicides, and a herbicide selected from the uracil class of herbicides, wherein glufosinate, salts or esters thereof, or L-glufosinate, salts or esters thereof, the herbicide selected from the phenoxyacetic class of herbicides, and the herbicide selected from the uracil class of herbicides are present in a ratio of 1:100:100 to 100:1:1, more preferably 1:10:10 to 10:1:1.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof; a herbicide selected from the phenoxyacetic class of herbicides; and a herbicide selected from the uracil class of herbicides, wherein the phenoxyacetic class herbicide is 2,4-D and the uracil class herbicide is saflufenacil.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, 2,4-D and saflufenacil, wherein the weight ratio of glufosinate, salts or esters thereof, or L-glufosinate, salts or esters thereof, 2,4-D and saflufenacil is 1:10:10 to 10:1:1, preferably 1:5:5 to 5:1:1.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, a herbicide selected from the pyridine class of herbicides, and a herbicide selected from the uracil class of herbicides.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, a herbicide selected from the pyridine class of herbicides, and a herbicide selected from the uracil class of herbicides, wherein glufosinate, salts or esters thereof, or L-glufosinate, salts or esters thereof, the herbicide selected from the pyridine class of herbicides, and the herbicide selected from the uracil class of herbicides are present in a ratio of 1:100:100 to 100:1:1, more preferably 1:10:10 to 10:1:1.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof; a herbicide selected from the pyridine class of herbicides; and a herbicide selected from the uracil class of herbicides, wherein the pyridine class herbicide is triclopyr and the uracil class herbicide is saflufenacil.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, triclopyr and saflufenacil, wherein the weight ratio of glufosinate, salts or esters thereof, or L-glufosinate, salts or esters thereof, triclopyr and saflufenacil is 1:10:10 to 10:1:1, preferably 1:5:5 to 5:1:1.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, and two herbicides selected from the imidazolinone class of herbicides.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, and two herbicides selected from the imidazolinone class of herbicides, wherein glufosinate, salts or esters thereof, or L-glufosinate, salts or esters thereof and the two herbicides selected from the imidazolinone class of herbicides are present in a ratio of 1:100:100 to 100:1:1, more preferably 1:10:10 to 10:1:1.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof; and two herbicides selected from the imidazolinone class of herbicides; wherein the imidazolinone class herbicides are imazapic and imazapyr.

In an embodiment, the present invention provides for a method of controlling the growth of undesirable vegetation at a locus, the method comprising treating the locus with a synergistic combination comprising glufosinate, salts or esters thereof, or L-glufosinate, salts or esters thereof, imazapic and imazapyr, wherein the weight ratio of glufosinate, salts or esters thereof, or L-glufosinate, salts or esters thereof, imazapic and imazapyr is 1:10:10 to 10:1:1, preferably 1:5:5 to 5:1:1.

The terms “g ai/h” as used herein denotes the concentration of the respective active ingredient in “grams” applied “per hectare” of the crop field.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the combination or composition comprises glufosinate, salts or esters thereof, or L-glufosinate, salts or esters thereof, in an amount in the range of 100 to 400 g ai/L, preferably 180 to 380 g ai/L, more preferably 250 to 350 g ai/L. In a preferred embodiment, the composition comprises 280 g ai/L of glufosinate, salts or esters thereof, or L-glufosinate, salts or esters thereof.

In an embodiment, the present invention provides a method of controlling weeds at a locus by treating said locus with a combination of glufosinate, salts or esters thereof, or L-glufosinate, salts or esters thereof and at least two herbicides or a composition comprising said combination, wherein glufosinate, salts or esters thereof or L-glufosinate, salts or esters thereof is applied at an application rate of 50-350 g ai/h, preferably 100 g ai/h to 250 g ai/h.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from nitrophenyl ether class of herbicides, and wherein the nitrophenyl ether class of herbicides is present in the composition in an amount in the range of 100 to 400 g ai/L, preferably 140 to 340 g ai/L, more preferably 200 to 250 g ai/L.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from nitrophenyl ether class of herbicides, and wherein the nitrophenyl ether class of herbicides is applied at an application rate of 5-250 g ai/h, preferably at a rate of 50-150 g ai/h and more preferably at a rate of 75-125 g ai/h.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from imidazoline class of herbicides, and wherein the imidazoline class of herbicides is present in the composition in an amount in the range of 10 to 250 g ai/L, preferably 50-200 g ai/L, more preferably 75-125 g ai/L.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from imidazoline class of herbicides, and wherein the imidazoline class of herbicides is present in the composition in an amount in the range of 100 to 1000 g ai/L, preferably 100-800 g ai/L.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from imidazoline class of herbicides, and wherein the imidazoline class of herbicides is applied at an application rate of 5-200 g ai/h, preferably at a rate of 10 to 150 g ai/h and more preferably at a rate of 10-100 g ai/h.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from organophosphorous class of herbicides, and wherein the organophosphorous class of herbicides is present in the composition in an amount in the range of 200 to 1000 g ai/L, preferably 400 to 800 g ai/L, more preferably 500-700 g ai/L.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from organophosphorous class of herbicides, and wherein the organophosphorous class of herbicides is applied at an application rate of 100-800 g ai/h, preferably at a rate of 200-500 g ai/h, more preferably 300-400 g ai/h.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from dicarboximide class of herbicides, and wherein the dicarboximide class of herbicides is present in the composition in an amount in the range of 200-800 g ai/L, preferably 300 to 700 g ai/L, more preferably 400-600 g ai/L.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from dicarboximide class of herbicides, and wherein the dicarboximide class of herbicides is applied at an application rate of 1 to 200 g ai/h, preferably 5-100 g ai/h, more preferably at a rate of 10-50 g ai/h.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from phenoxyacetic class of herbicides, and wherein the phenoxyacetic class of herbicides is present in the composition in an amount in the range of 200 to 1200 g ai/L, preferably 400-1000 g ai/L, more preferably 450-850 g ai/L.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from phenoxyacetic class of herbicides, and wherein the phenoxyacetic class of herbicides is present in the composition in an amount in the range of 400 to 1200 g ai/L, preferably 600-1000 g ai/L, more preferably 750-850 g ai/L.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from phenoxyacetic class of herbicides, and wherein the phenoxyacetic class of herbicides is applied at an application rate of 50-400 g ai/h, preferably 100-300 g ai/h, more preferably at a rate of 150-250 g ai/h.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from pyridine class of herbicides, and wherein the pyridine class of herbicides is present in the composition in an amount in the range of 300-1000 g ai/L, preferably 400 to 900 g ai/L, more preferably 400 to 750 g ai/L.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from pyridine class of herbicides, and wherein the pyridine class of herbicides is present in the composition in an amount in the range of 300-1000 g ai/L, preferably 400 to 900 g ai/L, more preferably 500 to 750 g ai/L.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from pyridine class of herbicides, and wherein the pyridine class of herbicides is applied at an application rate of 50-500 g ai/h, preferably at a rate of 100-400 g ai/h and more preferably 200-350 g ai/h.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from cyclohexene oxime class of herbicides, and wherein the cyclohexene oxime class of herbicides is present in the composition in an amount in the range of 100-400 g ai/L, preferably 150 to 350 g ai/L, more preferably 200-300 g ai/L.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from cyclohexene oxime class of herbicides, and wherein the cyclohexene oxime class of herbicides is applied at an application rate of 1-150 g ai/h, preferably at a rate of 10-100 g ai/h, more preferably 25-75 g ai/h.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from aryloxyphenoxypropionic class of herbicides, and wherein the aryloxyphenoxypropionic class of herbicides is present in the composition in an amount in the range of 1 to 250 g ai/L, preferably 10-200 g ai/L and more preferably 50-150 g ai/L.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from aryloxyphenoxypropionic class of herbicides, and wherein the aryloxyphenoxypropionic class of herbicides is applied at an application rate of 1-150 g ai/h, preferably at a rate of 10-100 g ai/h, more preferably 25-75 g ai/h.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from triazolone class of herbicides, and wherein the triazolone class of herbicides is present in the composition in an amount in the range of 100-800 g ai/L, preferably 200 to 600 g ai/L, more preferably 300 to 500 g ai/L.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from triazolone class of herbicides, and wherein the triazolone class of herbicides is applied at an application rate of 0.5-100 g ai/h, preferably at a rate of 1-50 g ai/h, more preferably 2-30 g ai/h.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from uracil class of herbicides, and wherein the uracil class of herbicides is present in the composition in an amount in the range of 1-1000 g ai/L, preferably 50 to 800 g ai/L.

In an embodiment, the present invention provides a method of controlling weeds at a locus by treating said locus with a combination of glufosinate, salts or esters thereof, or L-glufosinate, salts or esters thereof, and at least two herbicides or a composition comprising said combination, wherein the at least one herbicide is selected from uracil class of herbicides, and wherein the uracil class of herbicides is applied at an application rate of 10-150 g ai/h, preferably at a rate of 20-70 g ai/h.

The compositions of the present invention can be used in agricultural lands such as fields, paddy fields, lawns and orchards or in non-agricultural lands. The present invention may be used to control diseases in agricultural lands for cultivating the plants without any phytotoxicity to the plant. Examples of the crops on which the present compositions may be used include but are not limited to corn, rice, wheat, barley, rye, oat, Sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, Zelkova, Japanese arborvitae, fir wood, hemlock, juniper, Pinus, Picea, and Taxus cuspidate, etc.

In an embodiment, the combinations or the compositions of the present invention may be used for controlling a wide range of weeds such as Glycine max, Borreria verticillate, Eleusine indica, Amaranthus viridus, Lolium spp, Euphorbia heterophylla, Spermacoce verticillate, Spermacoce latifolia, and Brachiaria decumbens.

Examples of weeds controlled by the composition of the invention include, but are not limited to: Annual mercury, Black bindweed, Black medick, Black nightshade, Canadian fleabane, Charlock, Cleavers, Common amaranth, Common chickweed, Common fiddleneck, Common field-speedwell, Common fumitory, Common hemp-nettle, Common orache, Common poppy, Corn chamomile, Corn marigold, Corn spurrey, Cut-leaved crane's-bill, Dove's-foot crane's-bill, Dwarf spurge, Fat-hen, Field forget-me-not, Field Madder, Field pansy, Field penny-cress, Flixweed, Fool's parsley, Gallant soldiers, Garlic mustard, Groundsel, Hairy bittercress, Hairy Tare, Hedge mustard, Henbit dead-nettle, Himalayan balsam, Ivy-leaved speedwell, Knotgrass, Lesser trefoil, Long-headed poppy, Nipplewort, Oxford ragwort, Pale persicaria, Parsley piert, Petty spurge, Pineappleweed, Prickly lettuce, Prickly sow-thistle, Red dead-nettle, Redshank, Scarlet pimpernel, Scented mayweed, Scentless mayweed, Shepherd's purse, Small nettle, Smooth hawk's-beard, Smooth sow-thistle, Spear-leaved orache, Sticky mouse-ear, Stinking chamomile, Sun spurge, Swine cress, Thale cress, Thorn-apple, Wall speedwell, Wild radish, Annual meadow-grass, Barren brome, Black-grass, Soft brome, Wall Barley, Wild-oat, Winter wild-oat, Caper spurge, Evening-primrose, Giant hogweed, Goat's-beard, Hemlock, Hogweed, Spear thistle, Bracken, Field horsetail, Rushes, Bramble, Broad-leaved dock, Bulbous buttercup, Cat's-ear, Coltsfoot, Common mouse-ear, Common nettle, Common ragwort, Common sorrel, Common toadflax, Cow parsley, Creeping buttercup, Creeping thistle, Curled dock, Daisy, Dandelion, Field bindweed, Greater plantain, Ground elder, Ground-ivy, Hedge bindweed, Hoary cress, Japanese knotweed, Lesser celandine, Meadow buttercup, Mouse-ear-hawkweed, Mugwort, Perennial sowthistle, Perforate St John, Procumbent pearlwort, Ribwort plantain, Rosebay willowherb, Selfheal, Sheep's sorrel, Slender speedwell, Thyme-leaved speedwell, White campion, White clover, Yarrow, Black bent, Cock's-foot, Common bent, Common couch, Creeping bent, Creeping soft-grass, Onion couch, Perennial rye-grass, Rough meadow-grass, Yorkshire fog, Volunteer cereals, Volunteer oilseed rape, Volunteer Potato, Weed Beet, Alopecurus myosuroides Huds. (blackgrass, ALOMY), Amaranthus palmeri (Palmer amaranth, AMAPA) Amaranthus viridis (slender amaranth, AMAVI), Avena fatua (wild oat, AVEFA), Brachiaria decumbens Stapf. or Urochloa decumbens (Stapf), Brachiaria brizantha or Urochloa brizantha, Brachiaria platyphylla (Groseb.) Nash or Urochloa platyphylla (broadleaf signalgrass, BRAPP), Brachiaria plantaginea. or Urochloa plantaginea (alexandergrass, BRAPL), Cenchrus echinatus (southern sandbur, CENEC), Digitaria horizontalis Willd. (Jamaican crabgrass, DIGHO), Digitaria insularis (sourgrass, TRCIN), Digitaria sanguinalis (large crabgrass, DIGSA), Echinochloa crus-galli (barnyardgrass, ECHCG), Echinochloa colonum (junglerice, ECHCO), Eleusine indica Gaertn. (goosegrass, ELEIN), Lolium multiflorum Lam. (Italian ryegrass, LOLMU), Panicum dichotomiflorum Michx. (fall Panicum, PANDI), Panicum miliaceum L. (wild-proso millet, PANMI), Sesbania exaltata (hemp Sesbania, SEBEX), Setaria faberi Herrm. (giant foxtail, SETFA), Setaria viridis (green foxtail, SETVI), Sorghum halepense (Johnsongrass, SORHA), Sorghum bicolor, Moench ssp., Arundinaceum (shattercane, SORVU), Cyperus esculentus (yellow nutsedge, CYPES), Cyperus rotundus (purple nutsedge, CYPRO), Abutilon theophrasti (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida (giant ragweed, AMBTR), Anoda cristata (spurred Anoda, ANVCR), Asclepias syriaca (common milkweed, ASCSY), Bidens pilosa (hairy beggarticks, BIDPI), Borreria species (BOISS), Borreria alata or Spermacoce alata Aubl. or Spermacoce latifolia (broadleaf buttonweed, BOILF), Chenopodium album L. (common lambsquarters, CHEAL), Cirsium arvense (Canada thistle, CIRAR), Commelina benghalensis (tropical spiderwort, COMBE), Datura stramonium (jimsonweed, DATST), Daucus carota (wild carrot, DAUCA), Euphorbia heterophylla (wild poinsettia, EPHHL), Euphorbia hirta or Chamaesyce hirta (garden spurge, EPHHI), Euphorbia dentata Michx. (toothed spurge, EPHDE), Erigeron bonariensis or Conyza bonariensis (hairy fleabane, ERIBO), Erigeron canadensis or Conyza canadensis (horseweed, ERICA), Conyza sumatrensis (tall fleabane, ERIFL), Helianthus annuus (common sunflower, HELAN), Jacquemontia tamnifolia (smallflower morningglory, IAQTA), Ipomoea hederacea (ivyleaf morningglory, IPOHE), Ipomoea lacunosa (white morningglory, IPOLA), Lactuca serriola (prickly lettuce, LACSE), Portulaca oleracea (common purslane, POROL), Richardia species (pusley, RCHSS), Salsola tragus (Russian thistle, SASKR), Sida species (Sida, SIDSS), Sida spinosa (prickly Sida, SIDSP), Sinapis arvensis (wild mustard, SINAR), Solanum ptychanthum (eastern black nightshade, SOLPT), Tridax procumbens (coat buttons, TRQPR), Rumex dentatus (RUMDE) or Xanthium strumarium (common cocklebur, XANST), crabgrass complex (Digitaria horizontalis, Digitaria nuda and others), guinea grass (Panicum maximum), Surinam grass (Brachiaria decumbens), morning glories (Ipomoea grandifolia, Ipomoea nil, Ipomoea quamoclit, Ipomoea purpurea, Ipomoea hederifolia, Merremia cissoides and Merremia aegypta), beggar-ticks (Bidens pilosa), Java grass or purple nut sedge (Cyperus rotundus and Cyperus spp), Indian goosegrass or crowfoot grass (Eleusine indica), southern sandbur (Cenchrus echinatus), velvet bean or Mucuna (Mucuna pruriens), wild poinsettia or milkweed (Euphorbia heterophylla), Paraguayan starbur (Acanthospermum australe), Slender amaranth (Amaranthus viridis), Alexandergrass (Brachiaria plantaginea), Benghal dayflower (Commelina benghalensis), Lilac tasselflower (Emilia sonchifolia), Wild poinsettia or milkweed (Euphorbia heterophylla), Gallant soldier (Galinsoga parviflora), Purslane or pigweed (Portulaca oleracea), Brazilian calla-lily or Brazil pusley (Richardia brasiliensis), Flannel weed (Sida cordifolia), Southern Sida (Sida glaziovii), Southern Sida (Sida rhombifolia), Buttonweed or broad-leaved buttonweed (Spermacoce latifólia).

In a preferred embodiment, the weeds controlled by the combinations/compositions of the present invention include weedy Glycine max, Spermacoce latifolia, Eleusine indica and Brachiaria decumbens.

In a preferred embodiment, the weeds controlled by the combinations/compositions of the present invention include Borreria verticillata, Euphorbia heterophylla, Lolium spp., and Amaranthus spp.

The combinations of the present invention may be sold as a pre-mix composition or a kit of parts such that individual actives may be mixed before spraying. Alternatively, the kit of parts may contain the at least two herbicides pre-mixed and the glufosinate, salts or esters thereof or L-glufosinate, salts or esters thereof, packaged separately, such that the components may be tank mixed before spraying.

The method of control of the present invention may be carried out by spraying the suggested tank mixes, or the individual herbicides may be formulated as a kit-of-parts containing various components that may be mixed as instructed prior to spraying.

In an embodiment, the present invention provides a kit-of-parts comprising a plurality of components, wherein said plurality of components comprises:
a) a first component as glufosinate, salts or esters thereof or L-glufosinate, salts or esters thereof;
b) a second component comprising a herbicide selected from nitrophenyl ether, imidazolinone, organophosphorous, dicarboximide, phenoxyacetic, pyridine, cyclohexene oxime, aryloxyphenoxypropionic, triazolone, or uracil class of herbicides; and
c) a third component comprising a herbicide selected from nitrophenyl ether, imidazolinone, organophosphorous, dicarboximide, phenoxyacetic, pyridine, cyclohexene oxime, aryloxyphenoxypropionic, triazolone, or uracil class of herbicides.

In an embodiment, the kit-of-parts comprises an instructions manual, said instructions manual comprising instructions directing a user to admix the components before being used.

In an embodiment, each of the components of the present invention may be packaged separately and may be tank mixed at the time of spraying.

In another embodiment, the components of the present invention may be packaged as composition such that the glufosinate, salts or esters thereof or L-glufosinate, salts or esters thereof, and the at least two herbicides are formulated into one composition and other additives are packaged separately, such that the two maybe tank mixed at the time of spraying.

Surprisingly, it has been found by the present inventors, that when glufosinate, salts or esters thereof, or L-glufosinate, salts or esters thereof, and the at least two herbicides of the present invention, when applied individually, was ineffective in the control of weeds, but demonstrated excellent synergistic control on when applied together. The current invention therefore provides advantageous combinations, compositions and methods of controlling weeds.

The combinations of the present invention or compositions comprising the said combinations maybe applied simultaneously as a tank mix or a formulation or may be applied sequentially. The combinations may be a tank mixes of compositions of individual active ingredients. The application may be made as a foliar spray at different timings during crop development, with either one or two applications early or late post-emergence.

The present invention is more particularly described in the following examples that are intended as illustration only, since numerous modifications and variations within the scope of the present invention will be apparent to those of skill in the art. Unless otherwise noted, all parts, percentages, and ratios reported in the following examples are on a weight basis, and all reagents used in the examples were obtained or are available from the chemical suppliers.

The following examples illustrates the composition, underlying effect and basic methodology of the present invention.

### Examples

The following examples demonstrate the present invention.

### Composition:

A combination of L-glufosinate, Imazethapyr and carfentrazone was prepared with the following dosage of active ingredients (a.i.)

| Active ingredient | Amount a.i., g/L |
|---|---|
| L-glufosinate | 280 |
| Imazethapyr | 106 |
| Carfentrazone | 400 |

A combination of L-glufosinate, triclopyr and safluenacil was prepared with the following dosage of active ingredients (a.i.)

| Active ingredient | Amount a.i., g/L |
|---|---|
| L-glufosinate | 280 |
| Triclopyr | 480 |
| Saflufenacil | 700 |

A combination of L-glufosinate, 2,4D and saflufenacil was prepared with the following dosage of active ingredients (a.i.)

| Active ingredient | Amount a.i., g/L |
|---|---|
| L-glufosinate | 280 |
| 2,4D | 456 |
| Saflufenacil | 700 |

A combination of L-glufosinate, imazapic and imazapyr was prepared with the following dosage of active ingredients (a.i.)

| Active ingredient | Amount a.i., g/L |
|---|---|
| L-glufosinate | 280 |
| Imazapic + imazapyr | 525 + 175 |

### Evaluation of Post-Emergence Herbicidal Activity of Combinations Under Field Conditions

Methodology: Greenhouse trials were carried out to evaluate the efficacy of the combination of L-glufosinate and the other herbicides on weeds such as Glycine max, Spermacoce verticilata, Eleusine indica, Brachiaria decumbens. The soil used was sandy clay loam—Sand: 68.0%; Silt: 8.0%; Clay: 24.0%. All treatments were conducted in 4 replications per treatment with a spray volume of 150 L/h.

### Evaluation

The expected efficacy of a combination of L-glufosinate and the other herbicides was calculated using the well-established Colby method. Any difference between the observed and “expected” efficacy could be attributed to synergy between the two compounds.

In the Colby method, the expected (or predicted) response of a combination of herbicides is calculated by taking the product of the observed response for each individual component of the combination when applied alone, divided by 100, and subtracting this value from the sum of the observed response for each component when applied alone. An unexpected enhancement in efficacy of the combination is then determined by comparing the observed response of the combination to the expected (or predicted) response as calculated from the observed response of each individual component alone. If the observed response of the combination is greater than the expected (or predicted) response, or stated conversely, if the difference between the observed and expected response is greater than zero, then the combination is said to be synergistic or unexpectedly effective (Colby, S. R., Weeds, 1967(15), p. 20-22). The Colby method requires only a single dose of each herbicide applied alone and the mixture of both doses. The formula used to calculate the expected efficacy (EE) which was compared with the observed efficacy (OE) to determine the efficacy of the present invention is explained hereinbelow:

The expected efficacy for a combination of two active ingredients is as follows:

$$EE = ( A + B - ( A \times B ) / 100 )$$

The expected efficacy for a combination of three active ingredients is as follows:

$$EE = A + B + C - ( AB + AC + BC ) / 100 + ABC / 10 , 000$$

Where,
A=Observed efficacy of active ingredient A at the same concentration as used in the mixture.
B=Observed efficacy of the active ingredient B at the same concentration as used in the mixture.
C=Observed efficacy of the active ingredient C at the same concentration as used in the mixture.

TABLE 3
Table 3 demonstrates synergy on weeds using the combination of L-glufosinate,
imazethapyr and carfentrazone. The percentage efficacy was calculated for 14, 21, 28, 35 days
of applications (DAA). The target weed was weedy Glycine max, and the concentration of the
herbicide and the results are recorded the table 3 below:

| Active | | | | | | | | |
|---|---|---|---|---|---|---|---|---|
| ingredient, dose | 14 DAA | | 21 DAA | | 28 DAA | | 35 DAA | |
| a.i., g/h | Control % | Colby* | Control % | Colby* | Control % | Colby* | Control % | Colby* |
| L-glufosinate, | 60 | — | 63.3 | — | 63.3 | — | 52.7 | — |
| 150 | | | | | | | | |
| Imazethapyr, 75.0 | 10 | — | 20.0 | — | 20.0 | — | 15.0 | — |
| Carfentrazone, | 50.3 | — | 44.3 | — | 44.3 | — | 39.3 | — |
| 7.5 | | | | | | | | |
| L-glufosinate, | 89.3 | 82.1 | 95.3 | 83.6 | 96.7 | 83.6 | 96.0 | 75.6 |
| 150 + | | | | | | | | |
| imazethapyr, 75 + | | | | | | | | |
| carfentrazone, 7.5 | | | | | | | | |

*Expected control according to Colby's Formula

TABLE 4
Table 4 demonstrates synergy on weeds using the combination of L-glufosinate,
imazethapyr and carfentrazone. The percentage efficacy was calculated for 3, 7, 14, 21, 28, 35
days of applications (DAA). The target weed was weedy Eleusine indica, and the concentration
of the herbicide and the results are recorded the table 4 below:

| Active | 3 DAA | | 7 DAA | | 14 DAA | | 21 DAA | | 28 DAA | | 35 DAA | |
|---|---|---|---|---|---|---|---|---|---|---|---|---|
| ingredient, | Control | | Control | | Control | | Control | | Control | | Control | |
| dose a.i., g/h | % | Colby* | % | Colby* | % | Colby* | % | Colby* | % | Colby* | % | Colby* |
| L-glufosinate, | 15 | | 43.3 | | 41.3 | | 37.3 | | 28.3 | | 25.3 | |
| 150 | | | | | | | | | | | | |
| Imazethapyr, | 3.7 | | 8.3 | | 12 | | 12.7 | | 12.7 | | 10 | |
| 75.0 | | | | | | | | | | | | |
| Carfentrazone, | 8.7 | | 14 | | 12.3 | | 11 | | 7.7 | | 0 | |
| 7.5 | | | | | | | | | | | | |
| L-glufosinate, | 33.3 | 25.3 | 69.3 | 55.3 | 84.3 | 54.7 | 86.7 | 51.3 | 84.7 | 42.2 | 82.7 | 32.8 |
| 150 + | | | | | | | | | | | | |
| imazethapyr, | | | | | | | | | | | | |
| 75 + | | | | | | | | | | | | |
| carfentrazone, | | | | | | | | | | | | |
| 7.5 | | | | | | | | | | | | |

*Expected control according to Colby's Formula

TABLE 5
Table 5 demonstrates synergy on weeds using the combination of L-glufosinate,
imazethapyr and carfentrazone. The percentage efficacy was calculated for 7, 14, 21, 28, 35
days of applications (DAA). The target weed was weedy Spermacoce latifolia, and the
concentration of the herbicide and the results are recorded the table 5 below:

| Active | 7 DAA | | 14 DAA | | 21 DAA | | 28 DAA | | 35 DAA | |
|---|---|---|---|---|---|---|---|---|---|---|
| ingredient, | Control | | Control | | Control | | Control | | Control | |
| dose a.i., g/h | % | Colby* | % | Colby* | % | Colby* | % | Colby* | % | Colby* |
| L-glufosinate, | 35 | | 56.7 | | 56.7 | | 58.3 | | 58.3 | |
| 150 | | | | | | | | | | |
| Imazethapyr, | 13.3 | | 30 | | 36.7 | | 30 | | 26.7 | |
| 75.0 | | | | | | | | | | |
| Carfentrazone, | 58.3 | | 64.3 | | 64.3 | | 64.3 | | 63.3 | |
| 7.5 | | | | | | | | | | |
| L-glufosinate, | 89 | 76.5 | 99.7 | 89.2 | 99.7 | 90.2 | 100 | 89.6 | 100 | 88.8 |
| 150 + | | | | | | | | | | |
| imazethapyr, | | | | | | | | | | |
| 75 + | | | | | | | | | | |
| carfentrazone, | | | | | | | | | | |
| 7.5 | | | | | | | | | | |

*Expected control according to Colby's Formula

TABLE 6
Table 6 demonstrates synergy on weeds using the combination of L-glufosinate,
imazethapyr and carfentrazone. The percentage efficacy was calculated for 7, 14, 21, 28, 35
days of applications (DAA). The target weed was weedy Brachiaria decumbens, and the
concentration of the herbicide and the results are recorded the table 6 below:

| Active | 7 DAA | | 14 DAA | | 21 DAA | | 28 DAA | | 35 DAA | |
|---|---|---|---|---|---|---|---|---|---|---|
| ingredient, | Control | | Control | | Control | | Control | | Control | |
| dose a.i., g/h | % | Colby* | % | Colby* | % | Colby* | % | Colby* | % | Colby* |
| L-glufosinate, | 46 | | 54.3 | | 53.3 | | 48.3 | | 42 | |
| 150 | | | | | | | | | | |
| Imazethapyr, | 10 | | 10 | | 15 | | 10 | | 5 | |
| 75.0 | | | | | | | | | | |
| Carfentrazone, | 14 | | 16.7 | | 15 | | 5 | | 0 | |
| 7.5 | | | | | | | | | | |
| L-glufosinate, | 66 | 58.2 | 84.3 | 65.7 | 90 | 66.3 | 87.7 | 55.8 | 85.7 | 44.9 |
| 150 + | | | | | | | | | | |
| imazethapyr, | | | | | | | | | | |
| 75 + | | | | | | | | | | |
| carfentrazone, | | | | | | | | | | |
| 7.5 | | | | | | | | | | |

*Expected control according to Colby's Formula

TABLE 7
Table 7 demonstrates synergy on weeds using the combination of L-
glufosinate, triclopyr and saflufenacil. The percentage efficacy was
calculated for 7 days of applications (DAA). The target weed was
weedy Glycine max, and the concentration of the herbicide and the
results are recorded the table 7 below:

| | 7 DAA | |
|---|---|---|
| Active ingredient, dose a.i., g/h | Control % | Colby* |
| L-glufosinate, 150 | 71.9 | |
| Saflufenacil, 30 | 75.4 | |
| Triclopyr, 228 | 67.9 | |
| L-glufosinate, 150 + Saflufenacil, 30 + | 100 | 97.7 |
| Triclopyr, 228 | | |

*Expected control according to Colby's Formula

TABLE 8
Table 8 demonstrates synergy on weeds using the combination of
L-glufosinate, triclopyr and saflufenacil. The percentage efficacy
was calculated for 3 days of applications (DAA). The target weed
was Brachiaria decumbens, and the concentration of the herbicide
and the results are recorded the table 8 below:

| | 7 DAA | |
|---|---|---|
| Active ingredient, dose a.i., g/h | Control % | Colby* |
| L-glufosinate, 150 | 66.2 | |
| Saflufenacil, 30 | 30 | |
| Triclopyr, 228 | 0 | |
| L-glufosinate, 150 + Saflufenacil, 30 + | 77.5 | 76.3 |
| Triclopyr, 228 | | |

*Expected control according to Colby's Formula

TABLE 9
Table 9 demonstrates synergy on weeds using the combination of L-glufosinate, 2,4 D
and saflufenacil. The percentage efficacy was calculated for 21, 28 and 35 days of applications
(DAA). The target weed was weedy Glycine max, and the concentration of the herbicide and
the results are recorded the table 9 below:

| | | | |
|---|---|---|---|
| Active ingredient, | 21 DAA | 28 DAA | 35 DAA |

| dose a.i., g/h | Control % | Colby* | Control % | Colby* | Control % | Colby* |
|---|---|---|---|---|---|---|
| L-glufosinate, 150 | 57.5 | | 50.6 | | 47.5 | |
| Saflufenacil, 30 | 63.2 | | 52.5 | | 50.7 | |
| 2,4 D, 228 | 49.3 | | 43.8 | | 41 | |
| L-glufosinate, 150 + | 100 | 92 | 100 | 86.8 | 100 | 84.7 |
| Saflufenacil, 30 + | | | | | | |
| 2,4 D, 228 | | | | | | |

*Expected control according to Colby's Formula

TABLE 10
Table 10 demonstrates synergy on weeds using the combination of L-glufosinate,
imazapic and imazapyr. The percentage efficacy was calculated for 3, 7, 14, 21, 28 and 35 days
of applications (DAA). The target weed was Borreria verticillata, and the concentration of the
herbicide and the results are recorded the table 10 below:

| Active | | | | | | | | | | | | |
|---|---|---|---|---|---|---|---|---|---|---|---|---|
| ingredient, | 3 DAA | | 7 DAA | | 14 DAA | | 21 DAA | | 28 DAA | | 35 DAA | |
| | Control | | Control | | Control | | Control | | Control | | Control | |
| dose a.i., g/h | % | Colby* | % | Colby* | % | Colby* | % | Colby* | % | Colby* | % | Colby* |
| L-glufosinate, 150 | 50 | | 80 | | 95 | | 90 | | 90 | | 85 | |
| Imazapic and Imazap | 15 | | 20 | | 30 | | 30 | | 40 | | 55 | |
| yr, 31.5 + 10.5 | | | | | | | | | | | | |
| L-glufosinate, 150 | 70 | 57.5 | 95 | 84 | 100 | 96.5 | 100 | 93 | 100 | 94 | 100 | 93.25 |
| Imazapic and | | | | | | | | | | | | |
| Imazapyr, 31.5 + 10.5 | | | | | | | | | | | | |

* Expected control according to Colby's Formula

TABLE 11
Table 11 demonstrates synergy on weeds using the combination
of L-glufosinate, imazapic and imazapyr. The percentage efficacy
was calculated for 3 days of applications (DAA). The target
weed was Amaranthus viridus, and the concentration of the
herbicide and the results are recorded the table 11 below:

| | 3 DAA | |
|---|---|---|
| Active ingredient, dose a.i., g/h | Control % | Colby* |
| L-glufosinate, 150 | 50 | |
| Imazapic and Imazapyr, 31.5 + 10.5 | 35 | |
| L-glufosinate, 150 + Imazapic and | 70 | 67.5 |
| Imazapyr, 31.5 + 10.5 | | |

*Expected control according to Colby's Formula

TABLE 12
Table 12 demonstrates synergy on weeds using the combination of L-glufosinate,
imazapic and imazapyr. The percentage efficacy was calculated for 3, 7, 14 days of applications
(DAA). The target weed was Eleusine indica, and the concentration of the herbicide and the
results are recorded the table 12 below:

| Active | | | | | | |
|---|---|---|---|---|---|---|
| ingredient, dose | 3 DAA | | 7 DAA | | 14 DAA | |
| a.i., g/h | Control % | Colby* | Control % | Colby* | Control % | Colby* |
| L-glufosinate, 150 | 40 | | 50 | | 40 | |
| Imazapic and | 10 | | 15 | | 40 | |
| Imazapyr, 31.5 + 10.5 | | | | | | |
| L-glufosinate, | 50 | 46 | 65 | 57.5 | 70 | 64 |
| 150 + Imazapic | | | | | | |
| and Imazapyr, | | | | | | |
| 31.5+ 10.5 | | | | | | |

*Expected control according to Colby's Formula

The results in table 3-12 demonstrate the synergy between L-glufosinate, and two herbicides. The large difference between the observed and the expected efficacy clearly demonstrates the synergistic effect of the combination.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

1. An herbicidal combination comprising glufosinate, salts or esters thereof, and at least two herbicides selected from:
(a) nitrophenyl ether class of herbicides;
(b) imidazolinone class of herbicides;
(c) organophosphorous class of herbicides;
(d) dicarboximide class of herbicides;
(e) phenoxyacetic class of herbicides;
(f) pyridine class of herbicides;
(g) cyclohexene oxime class of herbicides;
(h) aryloxyphenoxypropionic class of herbicides;
(i) triazolone class of herbicides; and/or
(j) uracil class of herbicides.

2. The combination as claimed in claim 1, wherein the glufosinate, salts or esters thereof is L-glufosinate, salts or esters thereof.

3. The combination as claimed in claim 1, wherein the second and third herbicides are selected from within the different classes of herbicides.

4. The combination as claimed in claim 1, wherein the second and third herbicides are selected from within the same class of herbicides.

5. The combination as claimed in claim 1, wherein a weight ratio of glufosinate, salts or esters thereof and the at least two herbicides ranges from 1:100:100 to 100:1:1.

6. The combination as claimed in claim 1, wherein a weight ratio of glufosinate, salts or esters thereof and one of the two herbicides ranges from 1:100 to 100:1.

7. The combination as claimed in claim 1, wherein:
(a) the nitrophenyl ether class herbicide is selected from the group consisting of oxyfluorfen, acifluorfen, aclonifen, bifenox, chlomethoxyfen, chlornitrofen, etnipromid, fluorodifen, fluoroglycofen, fluoronitrofen, fomesafen, fucaomi, furyloxyfen, halosafen, lactofen, nitrofen, nitrofluorfen, and combinations thereof;
(b) the imidazolinone class herbicide is selected from the group consisting of imazethapyr, imazamethabenz, imazamox, imazapic, imazapyr, imazaquin, and combinations thereof;
(c) the organophosphorous class herbicide is selected from the group consisting of glyphosate, amiprofos-methyl, amiprophos, anilofos, bensulide, bilanafos, butamifos, clacyfos, 2,4-DEP, DMPA ((O-(2,4-dichlorophenyl)O-methyl isopropylphosphoramidothioate)), EBEP (ethyl bis(2-ethylhexyl)phosphinate), fosamine, glufosinate-P, piperophos, and combinations thereof;
(d) the dicarboximide class herbicide is selected from the group consisting of cinidon-ethyl, flumezin, flumiclorac, flumioxazin, flumipropyn, and combinations thereof;
(e) the phenoxyacetic class herbicide is selected from the group consisting of clacyfos, 4-CPA (p-Chlorophenoxyacetic acid), 2,4-D, 3,4-DA, MCPA (2-methyl-4-chlorophenoxyacetic acid), MCPA-thioethyl, 2,4,5-T and combinations thereof;
(f) the pyridine class herbicide is selected from the group consisting of aminopyralid, cliodinate, clopyralid, diflufenican, dithiopyr, florpyrauxifen, flufenican, fluroxypyr, halauxifen, haloxydine, picloram, picolinafen, pyriclor, pyroxsulam, thiazopyr, triclopyr, xyloxadine, and combinations thereof;
(g) the cyclohexene oxime class herbicide is selected from the group consisting of alloxydim, butroxydim, clethodim, cloproxydim, cycloxydim, profoxydim, sethoxydim, tepraloxydim, tralkoxydim, and combinations thereof;
(h) the aryloxyphenoxypropionic class herbicide is selected from the group consisting of chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, quizalofop-P-tefuryl, quizalofop-ethyl, trifop, and combinations thereof;
(i) the triazolone class herbicide is selected from the group consisting of amicarbazone, bencarbazone, carfentrazone, flucarbazone, ipfencarbazone, propoxycarbazone, sulfentrazone, thiencarbazone and combinations thereof; and/or
(j) the uracil class herbicide is selected from the group consisting of bromacil, isocil, lenacil, terbacil, benzfendizone, butafenacil, epyrifenacil, flupropacil, saflufenacil, tiafenacil, and combinations thereof.

8. The combination as claimed in claim 1, wherein:
(a) the nitrophenyl ether class herbicide is oxyfluorfen;
(b) the imidazolinone class herbicide is selected from imazethapyr, imazapic, imazapyr or combinations thereof;
(c) the organophosphorous class of herbicide is glyphosate;
(d) the dicarboximide class herbicide is flumioxazin;
(e) the phenoxyacetic class herbicide is 2,4-D;
(f) the pyridine class herbicide is triclopyr;
(g) the cyclohexene oxime class herbicide is clethodim;
(h) the aryloxyphenoxypropionic class herbicide is haloxyfop;
(i) the triazolone class herbicide is carfentrazone; and/or
(j) the uracil class herbicide is saflufenacil.

9. The combination as claimed in claim 1, wherein glufosinate, salts or esters thereof, is present in an amount in a range of 100 to 400 g ai/L.

10. The combination as claimed in claim 1, wherein:
(a) the nitrophenyl ether class herbicide present in an amount in the range of 100 to 400 g ai/L;
(b) the imidazolinone class herbicide present in an amount in the range of 10 to 250 g ai/L or 100-1000 g ai/L;
(c) the organophosphorous class herbicide present in an amount in the range of 200 to 1000 g ai/L;
(d) the dicarboximide class herbicide present in an amount in the range of 200-800 g ai/L;
(e) the phenoxyacetic class herbicide present in an amount in the range of 200 to 1200 g ai/L;
(f) the pyridine class herbicide present in an amount in the range of 300-1000 g ai/L;
(g) the cyclohexene oxime class herbicide present in an amount in the range of 100-400 g ai/L;
(h) the aryloxyphenoxypropionic class herbicide present in an amount in the range of 1 to 250 g ai/L;
(i) the triazolone class herbicide present in an amount in the range of 100-800 g ai/L; and/or
(j) the uracil class herbicide present in an amount in the range of 1-1000 g ai/L.

11. An herbicidal composition comprising the combination as claimed in claim 1, and at least one agrochemically suitable excipient.

12. The composition as claimed in claim 11, wherein the composition is a tank-mix composition.

13. A method of controlling the growth of undesirable vegetation at a locus, the method comprising treating the locus with an herbicidal combination or a composition as claimed in claim 1.

14. The method as claimed in claim 13, wherein the glufosinate is applied at an application rate of 50-350 g ai/h.

15. The method as claimed in claim 13, wherein at least two herbicides are selected from
(a) the nitrophenyl ether class herbicide applied at an application rate of 5-250 g ai/h;
(b) the imidazolinone class herbicide applied at an application rate of 5-200 g ai/h;
(c) the organophosphorous class herbicide applied at an application rate of 100-800 g ai/h;
(d) the dicarboximide class herbicide applied at an application rate of 1 to 200 g ai/h;
(e) the phenoxyacetic class herbicide applied at an application rate of 50-400 g ai/h;
(f) the pyridine class herbicide applied at an application rate of 50-500 g ai/h;
(g) the cyclohexene oxime class herbicide applied at an application rate of 1-150 g ai/h;
(h) the aryloxyphenoxypropionic class herbicide applied at an application rate of 1-150 g ai/h;
(i) the triazolone class herbicide applied at an application rate of 0.5-100 g ai/h; and/or
(j) the uracil class herbicide applied at an application rate of 10-150 g ai/h.

16. An herbicidal combination comprising glufosinate, salts or esters thereof, or L-glufosinate, salts or esters thereof, a pyridine class herbicide and an uracil class herbicide.

17. The combination as claimed in claim 16, wherein the pyridine class herbicide is triclopyr.

18. The combination as claimed in claim 16, wherein the uracil class herbicide is saflufenacil.

19. An herbicidal combination comprising glufosinate, salts or esters thereof, or L-glufosinate, salts or esters thereof, a phenoxyacetic class herbicide and an uracil class herbicide.

20. The combination as claimed in claim 19, wherein the phenoxyacetic class herbicide is 2,4-D.

21. The combination as claimed in claim 19, wherein the uracil class herbicide is saflufenacil.

22. An herbicidal combination comprising glufosinate, salts or esters thereof, or L-glufosinate, salts or esters thereof, and two herbicides selected from the imidazolinone class herbicides.

23. The combination as claimed in claim 22, wherein the imidazolinone herbicides are imazapic and imazapyr.
